(19) United States
(12) Patent Application Publication
(10) Pub. No.: US 2005/0047645 A1
(43) Pub. Date: Mar. 3, 2005

(54) Method for interaction with status and control apparatus

(75) Inventors: Merritt Funk, Austin, TX (US); Wei Chen, San Antonio, TX (US)

Correspondence Address: PILLSBURY WINTHROP, LLP, P.O. BOX 10500, MCLEAN, VA, 22102, US

(73) Assignee: Tokyo Electron Limited, Tokyo (JP)

(21) Appl. No.: 10/951,161

(22) Filed: Sep. 28, 2004

Related U.S. Application Data
(63) Continuation of application No. PCT/US03/08022, filed on Mar. 18, 2003.
(60) Provisional application No. 60/368,162, filed on Mar. 29, 2002.

(51) Int. Cl. G06K 9/00

(52) U.S. Cl. 382/145; 382/144; 382/147

(57) ABSTRACT

A GUI is presented for managing a semiconductor processing system that is comprehensible and standardized in format. The graphical display is organized so that all significant parameters are clearly and logically displayed so that the user is able to perform the desired data collection, monitoring, modeling, and troubleshooting tasks with as little input as possible. The GUI is web-based and is viewable by a user using a web browser. The GUI allows a user to display real-time tool and process module statuses based upon process module events and alarm messages, historical data numerically and/or graphically, SPC charts, APC system logs, and Alarm logs. In addition, the GUI allows a user to print graphs and reports, to save data to files, to export data, to import data, and set up or modify the system.

This is a continuation application of International Application No: PCT/US03/08022, filed Mar. 28, 2003 and derives the benefit of the filing date of U.S. Provisional Patent Application No. 60/368,162, filed Mar. 29, 2002, the entire contents of both of which are incorporated herein by reference in their entireties.

### FIELD OF THE INVENTION

The present invention is related to semiconductor processing systems, particularly to a semiconductor processing system, which uses Graphical User Interfaces (GUIs) to manage data.

### BACKGROUND OF THE INVENTION

Computers are generally used to control, monitor, and analyze manufacturing processes due to complexities in a semiconductor manufacturing plant from the reentrant wafer flows, critical processing steps, and maintenance of the processes. Various input/output (I/O) devices are used to control and monitor process flows, wafer states, and maintenance schedules. A variety of tools exist in a semiconductor manufacturing plant to complete these complicated steps. Most tool monitoring and control analysis is accomplished using a display screen that is part of the graphical user interface (GUI) of a control computer.

Semiconductor processing facilities require constant monitoring. Processing conditions change over time with the slightest changes in critical process parameters creating undesirable results. Small changes can easily occur in the composition or pressure of an etch gas, process module, or wafer temperature. In many cases, changes of process data reflecting deterioration of processing characteristics cannot be detected by simply referring to the process data displayed. It is difficult to detect early stage abnormalities and characteristic deterioration of a process. Oftentimes prediction and pattern recognition offered by advanced process control (APC) is necessary.

Facility control is often performed by a number of different control systems having a variety of controllers. Some of the control systems may have man-machine interfaces such as touch screens, while others may only collect and display one variable such as temperature. The monitoring system must be able to collect data tabulated for the process control system. The data collection of the monitoring system must handle univariate and multivariate data, the analysis and display of the data, and have the ability to select the process variables to collect. Various conditions in a process are monitored by different sensors provided in each of the process modules, and data of the monitored conditions is transferred and accumulated in a control computer. If the process data is displayed and detected automatically, the process conditions of a mass-production line can be set and controlled through statistical process control (SPC) charts. Inefficient monitoring of a facility can result in facility downtimes that add to the overall operational cost.

### SUMMARY OF THE INVENTION

Accordingly, it is an object of the present invention to provide an Advanced Process Control (APC) System, for managing a semiconductor processing system, comprising Graphical User Interface (GUI) screens, the GUI screens comprising: a web-based logon GUI screen for providing a secure entry point; a plurality of GUI status screens for viewing current status of the semiconductor processing system, wherein at least one GUI status screen is accessible from the logon screen; a plurality of GUI configuration screens for configuring the semiconductor processing system; and a plurality of data manager GUI screens for managing historical and real-time data for the semiconductor processing system.

It is another object of the present invention to provide a method for managing a semiconductor processing system using an Advanced Process Control (APC) System comprising Graphical User Interface (GUI) screens, the method comprising: providing a secure entry point using a web-based logon screen; providing a plurality of GUI status screens for viewing current status of the semiconductor processing system, wherein at least one GUI status screen is accessible from the logon screen; providing a plurality of GUI configuration screens for configuring the semiconductor processing system; and providing a plurality of data manager GUI screens for managing historical and real-time data for the semiconductor processing system

### BRIEF DESCRIPTION OF THE DRAWINGS

A more complete appreciation of the invention and many of the attendant advantages thereof will become readily apparent with reference to the following detailed description, particularly when considered in conjunction with the accompanying drawings, in which:

FIG. 1 shows an exemplary block diagram of an APC system in a semiconductor manufacturing environment in accordance with one embodiment of the present invention;

FIG. 2A shows an exemplary view of a logon screen and FIG. 2B shows an exemplary view of a selection screen in accordance with one embodiment of the present invention;

FIG. 3 shows an exemplary view of a system configuration panel in accordance with one embodiment of the present invention;

FIGS. 4A-4C show exemplary views of sensor configuration panels in accordance with one embodiment of the present invention;

FIGS. 5A-5C show exemplary views of module configuration panels in accordance with one embodiment of the present invention;

FIGS. 6A-6C show exemplary views of sensor instantiation panels in accordance with one embodiment of the present invention;

FIG. 7 shows an exemplary view of a module pause configuration panel in accordance with one embodiment of the present invention;

FIGS. 8A-8D show exemplary views of alarm configuration panels in accordance with one embodiment of the present invention;

FIG. 9 shows an exemplary view of a tool status panel in accordance with one embodiment of the present invention;

FIG. 10 shows an exemplary view of a process module status panel in accordance with one embodiment of the present invention;

FIGS. 11A-11E show exemplary views of chart selection panels in accordance with one embodiment of the present invention;

FIGS. 12A-12C show exemplary views of SPC chart panels in accordance with one embodiment of the present invention;

FIG. 13 shows an exemplary view of an alarm log panel in accordance with one embodiment of the present invention;

FIGS. 14A-14B show exemplary views of data collection strategy panels in accordance with one embodiment of the present invention;

FIGS. 15A-15G show exemplary views of data collection plan (DCP) panels in accordance with one embodiment of the present invention;

FIGS. 16A-16B show exemplary views of analysis strategy panels in accordance with one embodiment of the present invention;

FIG. 17 shows an exemplary view of an analysis plan panel in accordance with one embodiment of the present invention;

FIGS. 18A-18C show exemplary views of SPC plan panels in accordance with one embodiment of the present invention;

FIGS. 19A-19C show exemplary views of PCA plan panels in accordance with one embodiment of the present invention;

FIGS. 20A-20C show exemplary views of PLS plan panels in accordance with one embodiment of the present invention; and

FIGS. 21A-21E show exemplary views of file output plan panels in accordance with one embodiment of the present invention.

### DETAILED DESCRIPTION OF AN EMBODIMENT

In semiconductor manufacturing processes computers are generally used to setup, monitor, and control manufacturing processes. The present invention provides an APC system comprising a GUI component for controlling and monitoring the process-related elements in a semiconductor-processing environment. Process-related elements can include tools, chambers, sensors, and processes. The GUI component comprises GUI panels/screens that are comprehensible, standardized in format, and simplify the management of the process-related elements. The graphical display is organized so that all significant parameters are clearly and logically displayed so that the user is able to perform the desired configuration, data collection, monitoring, modeling, and troubleshooting tasks with as little input as possible.

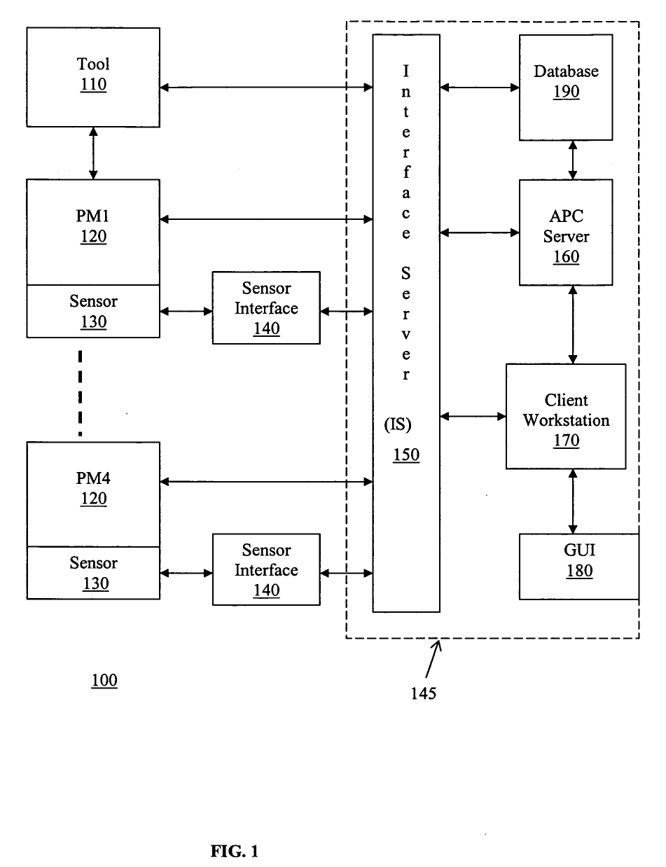

FIG. 1 shows an exemplary block diagram of an APC system in a semiconductor manufacturing environment in accordance with one embodiment of the present invention. In the illustrated embodiment, semiconductor manufacturing environment 100 comprises at least one semiconductor processing tool 110, multiple process modules 120, PM1 through PM4, multiple sensors 130 for monitoring the tool, the modules, and processes, sensor interface 140, and APC system 145. APC system 145 can comprise interface server (IS) 150, APC server 160, client workstation 170, GUI component 180, and database 190. In one embodiment, IS 150 can comprise a real-time memory database that can be viewed as a “Hub”.

In the illustrated embodiment, a single tool 110 is shown along with four process modules 120, but this is not required for the invention. The APC system 145 can interface with a number of processing tools including cluster tools having one or more process modules. For example, the tools can be used to perform etching, deposition, diffusion, cleaning, measurement, polishing, developing, transfer, storage, loading, and unloading processes.

In one embodiment, processing tool 110 can comprise a tool agent (not shown), which can be a software process that runs on a tool 110 and which can provide event information, context information, and start-stop timing commands used to synchronize data acquisition with the tool process. Also, APC system 145 can comprise an agent client (not shown) that can be a software process that can be used to provide a connection to the tool agent.

In one embodiment, IS 150 communicates using sockets. For example, the interface can be implemented using TCP/IP socket communication. Before every communication, a socket is established. Then a message is sent as a string. After the message is sent, the socket is cancelled.

Alternately, an interface can be structured as a TCL process extended with C/C++ code, or a C/C++ process that uses a special class, such as a Distributed Message Hub (DMH) client class. In this case, the logic, which collects the process/tool events through the socket connection can be revised to insert the events and their context data into a table in IS 150.

The tool agent can send messages to provide event and context information to the APC system. For example, the tool agent can sent lot start/stop messages, batch start/stop messages, wafer start/stop messages, recipe start/stop messages, and process start/stop messages. In addition, the tool agent can be used to send and/or receive set point data and to send and/or receive maintenance counter data.

When a processing tool comprises internal sensors, this data can be sent to the IS 150 and APC server 160. Data files can be used to transfer this data. For example, some processing tools can create trace files that are compressed in the tool when they are created. Compressed and/or uncompressed files can be transferred. When trace files are created in the processing tool, the trace data may or may not include end point detection (EPD) data. The trace data provides important information about the process. The trace data can be updated and transferred after the processing of a wafer is completed. Trace files are be transferred to the proper directory for each process. In one embodiment, tool trace data, maintenance data, and EPD data can be obtained from a processing tool 110.

In FIG. 1, four process modules are shown, but this is not required for the invention. The semiconductor processing system can comprise any number of processing tools having any number of process modules associated with them and independent process modules. The APC system 145 can collect, provide, process, store, and display data from processes involving processing tools, process modules, and sensors.

Process modules can be identified using data such as ID, module type, gas parameters, and maintenance counters, and this data can be saved into a database. When a new process module is configured, this type of data can be provided using a module configuration screen in GUI component 180. For example, the APC system can support the following module types from Tokyo Electron Limited: a Unity SCCM chamber, a Unity DRM oxide chamber, a Telius DRM oxide chamber, a Telius SCCM oxide chamber, and a Telius SCCM Poly chamber. Alternately, the APC system can support other chambers.

In the illustrated embodiment, a single sensor 130 is shown along with an associated process module, but this is not required for the invention. Any number of sensors can be coupled to a process module. Sensor 130 can comprise an OES sensor, a VIP sensor, an analog sensor, and other types of semiconductor processing sensors including digital probes. The APC data management applications can be used to collect, process, store, display, and output data from a variety of sensors.

In the APC system, sensor data can be provided by both external and internal sources. External sources can be defined using an external data recorder type; a data recorder object can be assigned to each external source; and a state variable representation can be used.

Sensor configuration information combines sensor type and sensor instance parameters. A sensor type is a generic term that corresponds to the function of the sensor. A sensor instance pairs the sensor type to a specific sensor on a specific process module and tool. At least one sensor instance is configured for each physical sensor that is attached to a tool.

For example, an OES sensor can be one type of sensor; a VI probe can be another type of sensor, and an analog sensor can be a different type of sensor. In addition, there can be additional generic types of sensors and additional specific types of sensors. A sensor type includes all of the variables that are needed to set up a particular kind of sensor at run time. These variables can be static (all sensors of this type have the same value), configurable by instance (each instance of the sensor type can have a unique value), or dynamically configurable by a data collection plan (each time the sensor is activated at run time, it can be given a different value).

A “configurable by instance” variable can be the sensor/probe IP address. This address varies by instance (for each process chamber) but does not vary from run to run. A “configurable by data collection plan” variable can be a list of harmonic frequencies. These can be configured differently for each wafer based on the context information. For example, wafer context information can include tool ID, module ID, slot ID, recipe ID, cassette ID, start time and end time. There can be many instances of the same sensor type. A sensor instance corresponds to a specific piece of hardware and connects a sensor type to the tool and/or process module (chamber). In other words, a sensor type is generic and a sensor instance is specific.

The APC system 145 can comprise a recorder application that can include a plurality of methods created for starting up, setting up, shutting down, and collecting data from sensor 130. In one case, there can be two recorders used for a probe: one for single frequency mode, and one for a multi frequency mode. A global state variable can be used to keep track of the current state of the recorder, and the states can be idle, ready, and recording.

For example, a recorder application can comprise a start recorder method that can be triggered by a recipe start event. Also, the recorder application can comprise a sensor setup method that can be triggered by a start event such as a wafer-in event. Furthermore, the recorder application can comprise an end recording method that can be called as a result of a wafer-out event.

The APC system 145 can also comprise a data management application for processing the data from sensor 130. For example, a Dynamic Loadable Library (DLL) function, written in C, can be used to parse data from sensor 130 and format it suitable for printing to the output file. The DLL function can take a string from the sensor as a parameter, and return the printable (tab-delimited) string as a second argument.

As shown is FIG. 1, sensor interface 140 can be used to provide an interface between sensor 130 and the APC system 145. For example, APC system 145 can be connected to sensor interface 140 via an internet or intranet connection, and sensor interface 140 can be connected to sensor 130 via an internet or intranet connection. Also, sensor interface 140 can act as a protocol converter, media converter, and data buffer. In addition, sensor interface 140 can provide real-time functions, such as data acquisition, peer-to-peer communications, and I/O scanning. Alternately, sensor interface 140 can be eliminated, and the sensor 130 can be directly coupled to APC system 145.

Sensor 130 can be a static or dynamic sensor. For example, a dynamic VI sensor can have its frequency range, sampling period, scaling, triggering, and offset information established at run-time using parameters provided by a data collection plan. Sensor 130 can be an analog sensor that can be static and/or dynamic. For example, analog sensors can be used to provide data for ESC voltage, matcher parameters, gas parameters, flow rates, pressures, temperatures, RF parameters, and other process related data. Sensor 130 can comprise at least one of a: VIP probe, OES sensor, analog sensor, digital sensor, and a semiconductor processing sensor.

In one embodiment, a sensor interface can write the data points to a raw data file. For example, IS 150 can send a start command to the sensor interface to initiate data acquisition and can send a stop command to cause the file to be closed. IS 150 can then read and parse the sensor data file, process the data and post the data values into the in-memory data tables.

Alternately, the sensor interface could stream the data in real time to the IS 150. A switch could be provided to allow the sensor interface to write the file to disk. The sensor interface can also provide a method to read the file and stream the data points to the IS 150 for off-line processing and analysis.

As shown in FIG. 1, APC system 145 can comprise a database 190. Raw data and trace data from the tool can be stored as files in the database 190. The amount of data depends on the data collection plans configured by the user, as well as the frequency with which processes are performed and processing tools are run. The data obtained from the processing tools, the processing chambers, the sensors, and the APC system is stored in tables.

In one embodiment, the tables can be implemented in the IS 150 as in-memory tables and in database 190 as persistent storage. The IS 150 can use Structured Query Language (SQL) for column and row creation as well as posting data to the tables. The tables can be duplicated in the persistent tables in database 190 (i.e., DB2 can be used) and can be populated using the same SQL statements.

In the illustrated embodiment, IS 150 can be both an in-memory real-time database and a subscription server. For example, client processes are able to perform database functions using SQL with the familiar programming model of relational data tables. In addition, the IS 150 can provide a data subscription service where the client software receives asynchronous notification whenever data that meets their selection criteria is inserted, updated, or deleted. A subscription uses the full power of an SQL select statement to specify which table columns are of interest and what row selection criteria is used to filter future data change notifications.

Because the IS 150 is both a database and a subscription server, clients can open “synchronized” subscriptions to existing table data when they are initialized. The IS 150 provides data synchronization through a publish/subscribe mechanism, in-memory data tables, and supervisory logic for marshalling events and alarms through the system. The IS 150 provides several messaging TCP/IP based technologies including sockets, UDP, and publish/subscribe.

For example, the IS 150 architecture can use multiple data hubs (i.e., SQL databases) that can provide real-time data management and subscription functions. Application modules and user interfaces use SQL messages to access and update information in the data hub(s). Due to performance limitations associated with posting run time data to the relational database, run time data is posted to in-memory data tables managed by the IS 150. The contents of these tables can be posted to the relational database at the end of wafer processing.

In the illustrated embodiment shown in FIG. 1, a single client workstation 170 is shown but this is not required for the invention. The APC system 145 can support a plurality of client workstations 170. In one embodiment, the client workstation 170 allows a user to view status including tool, chamber, and sensor status; to view process status; to view historical data; and to perform modeling and charting functions.

The APC system can comprise a database 190 and the APC system, on a daily basis, archives the wafer runs that were processed on the preceding day to a file stored in database 190. The data in the APC database 190 can be used for charting and/or analysis plan execution. For example, this file can include the raw data for each wafer, the summary data for each wafer and each lot, and the tool data and alarm events that are associated with the wafer. The data for all the process runs can be stored in an archive directory in database 190 using a zip file that corresponds to a specific day (YYYYMMDD.zip). These archive files can be copied off the APC server 160 and to a client workstation 170 or another computer using the network or onto portable media.

In the illustrated embodiment shown in FIG. 1, APC system 145 can comprise an APC server 160 that can be coupled to IS 150, client Workstation 170, GUI component 180, and database 190, but this is not required for the invention. The APC server 160 can comprise a number of applications including at least one tool-related application, at least one module-related application, at least one sensor-related application, at least one IS-related application, at least one database-related application, and at least one GUI-related application.

The APC server 160 comprises at least one computer and software that supports multiple process tools; collects and synchronizes data from tools, process modules, sensors, and probes; stores data in a database, enables the user to view existing charts; and provides fault detection. The APC server allows online system configuration, online lot-to-lot fault detection, online wafer-to-wafer fault detection, online database management, and performs multivariate analysis of summary data using models based upon historical data.

For example, APC server 160 can comprise a minimum of 3 GB available disk space; at least 600 MHz CPU (Dual processors); a minimum 512 Mb RAM (physical memory); a 9 GB SCSI hard drives in a RAID 5 configuration; a minimum disk cache that is twice the RAM size; Windows 2000 server software installed; Microsoft Internet Explorer; TCP/IP Network protocol; and at least two network cards.

APC system 145 can comprise at least one storage device that stores files containing raw data from sensors and files containing trace data from the tool. If these files are not managed properly (i.e., deleted regularly), the storage device can run out of disk space, and can stop collecting new data. The APC system 145 can comprise a data management application that allow the user to delete older files, thereby freeing disk space so that data collection can continue without interruption. The APC system 145 can comprise a plurality of tables that are used to operate the system, and these tables can be stored in database 190. In addition, other computers (not shown), such as on-site or off-site computers/workstations and/or hosts, can be networked to provide functions such as data/chart viewing, SPC charting, EPD analysis, file access, for one or many tools.

As shown in FIG. 1, the APC system 145 can comprise a GUI component 180. For example, a GUI component can run as an application on the APC server 160, client workstation 170, and tool 110.

GUI component 180 enables an APC system user to perform the desired configuration, data collection, monitoring, modeling, and troubleshooting tasks with as little input as possible. The GUI design complies with the SEMI Human Interface Standard for Semiconductor Manufacturing Equipment (SEMI Draft Doc. #2783B) and with the SEMATECH. Strategic Cell Controller (SCC) User-Interface Style Guide 1.0 (Technology Transfer 92061179A-ENG). Those skilled in the art will recognize that GUI screens can comprise a left-to-right selection tab structure and/or a right-to-left structure, a bottom-to-top structure, a top-to-bottom structure, or a combination structure.

GUI component 180 provides a means of interaction between the APC system 145 and the user. When the GUI begins, a logon screen that validates the user identification and password can be displayed and that provides a first level of security. Desirably, users can be registered using a security application before logging on. A database check of user identification indicates an authorization level, which will streamline the GUI functions available. Selection items for which the user is not authorized can be displayed differently and unavailable. The security system also allows a user to change an existing password. For example, the logon screen can be opened from a browser tool such as Netscape or Internet Explorer. A user can enter a user ID and password in the logon fields.

One or more GUI screens can include a title panel located along the top of the screen, an information panel to display user information, and a control panel at the bottom of the screen. The GUI can create and view plots of summary data and trace data, and display web screens showing the status based on the last wafer and in real-time, view alarm logs, and configure the system.

GUI component 180 provides easy to use interfaces that enable users to: view tool status and process module status; create and edit x-y charts of summary and raw (trace) parametric data for selected wafers; view tool alarm logs; configure data collection plans that specify conditions for writing data to the database or to output files; input files to statistical process control (SPC) charting, modeling and spreadsheet programs; generate Wafer Reports, which detail processing information for specific wafers, and Database Save Reports, which detail what data is currently being saved to the database; create and edit SPC charts of process parameters, and set SPC alarms which generate email warnings; run multivariate Principal Components Analysis (PCA) models for fault detection; view diagnostics screens in order to troubleshoot and report problems with the APC Controller.

In addition, authorized users and administrators can use GUI screens to modify system configuration and sensor setup parameters. With an offline workstation, GUI component 180 provides users with user-friendly screens for developing multivariate PCA models for fault detection.

The GUI component 180 can comprise a configuration component for allowing a user to configure processing tools, processing modules, sensors, and the APC system. For example, GUI configuration screens can be provided for at least one of a processing tool, a processing module, a sensor, a sensor instance, a module pause, and an alarm. Configuration data can be stored in an attribute database table and can be set up with the defaults at the installation.

The GUI component 180 can comprise a status component for displaying the current status for processing tools, processing modules, sensors, and the APC system. In addition, the status component can comprise a charting component for presenting system-related and process-related data to a user using one or more different types of charts.

The GUI component can comprise a data manager component for creating, editing, and viewing strategies and plans used to collect, store, and analyze data.

Also, GUI component 180 can comprise a real-time operational component. For example, a GUI component can be coupled to a background task, and shared system logic can provide the common functionality used both by the background task and by the GUI component. Shared logic can be used to guarantee that the returned values to the GUI component are the same as the ones returned to the background task. Furthermore, the GUI component 180 can comprise an APC file management GUI component and a security component.

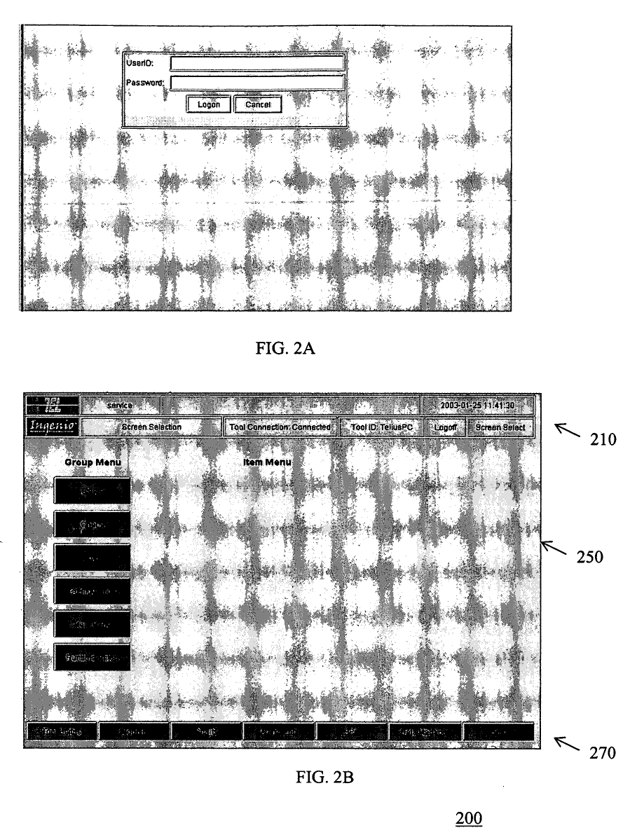

FIG. 2A shows an exemplary view of a logon screen in accordance with one embodiment of the present invention. For example, fields can be provided for a user ID and a password. The logon screen can provide a secure entry point. A logon screen can be used to discriminate between different user levels, such as a first level user, a second level user, and a third level user. For example, a first level user can be restricted to viewing status screens.

FIG. 2B shows an exemplary view of a selection screen in accordance with one embodiment of the present invention. In the illustrated embodiment, menu GUI screen 200 comprises a title panel 210, an information panel 250, and a control panel 270. Information Panel 250 can comprise a plurality of selection items. For example, selection items can be shown and can include at least one of a status selection item, a charts selection item, a logs selection item, a configuration selection item, a main menu selection item, a runtime setup selection item, and a data manager selection item. In alternate embodiments, the selection items can be shown as tabs, pictures, icons, groups, menus, and/or drop-down lists.

In the illustrated embodiment, title panel 210 comprises the top portion of the screen. For example, a title panel 210 can comprise: company logo field; a product information field; a user ID field displays the ID of the current user; an alarm message field can display a message when there is an active alarm (otherwise, this field is blank); a current date and time field can display the current date and time of the server; current screen name field can display the name of the current screen; a communication status field can display current status for communications link between server and tool; a tool ID field can display the ID of the tool being monitored; a logoff field can allow a user to log off; and a screen select field can be selected to navigate between GUI screens and/or panels. Alternately, a GUI screen can comprise one or more navigation bars that can comprise selection items. In other embodiments, a title panel is not required.

As shown in the illustrated embodiment, a control panel 270 can comprise selection items and can be located along the bottom of the screen. For example, these selection items can enable the user to display at least one of a status screen, a chart screens, an alarm screen, a SPC screens, a data manager screen, a menu screen, and a help screen. In alternate embodiments, a control panel is not required.

In alternate embodiments, these selection items can be displayed in different languages, in different configurations, and can be sized and positioned differently.

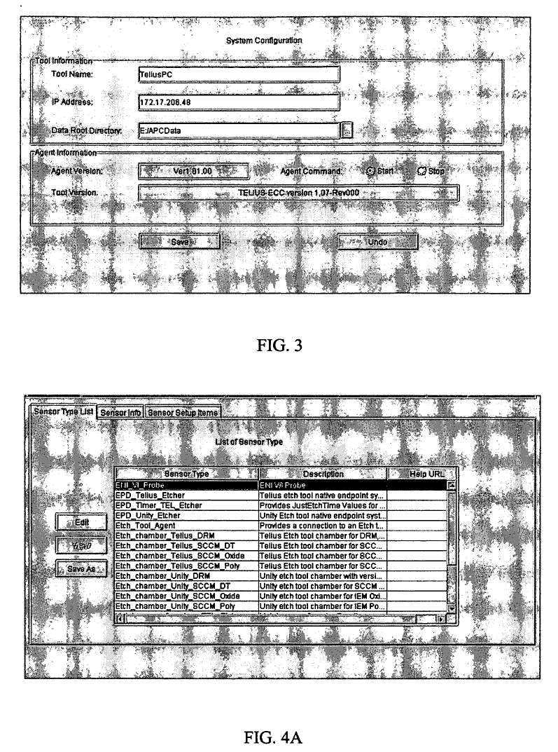

FIG. 3 shows an exemplary view of a system configuration panel in accordance with one embodiment of the present invention. In the illustrated embodiment, a processing tool configuration panel is shown. For example, a system configuration panel can be accessed by a user using a selection item such as a button, a tab, a list item, a menu item, and/or a visual descriptor. Alternately, a processing system configuration screen/panel can be shown.

A user can use a configuration panel such as shown in FIG. 3 to configure one or more processing tools and/or simulators. For example, the user can input and/or edit the following information: tool name, the type of tool, the data root directory, the IP address of the tool, the Agent version, the agent command, the tool version, and the process modules installed. As an example, an etch-related processing tool is shown, but this is not required for the invention. Alternately, other and/or additional processing tools can be shown. For example, deposition tools, diffusion tools, cleaning tools, transfer tools, measurement tools, polishing tools, and other types of semiconductor processing tools can be used. In addition, the GUI allows users to configure and use tool simulators for off-line analysis.

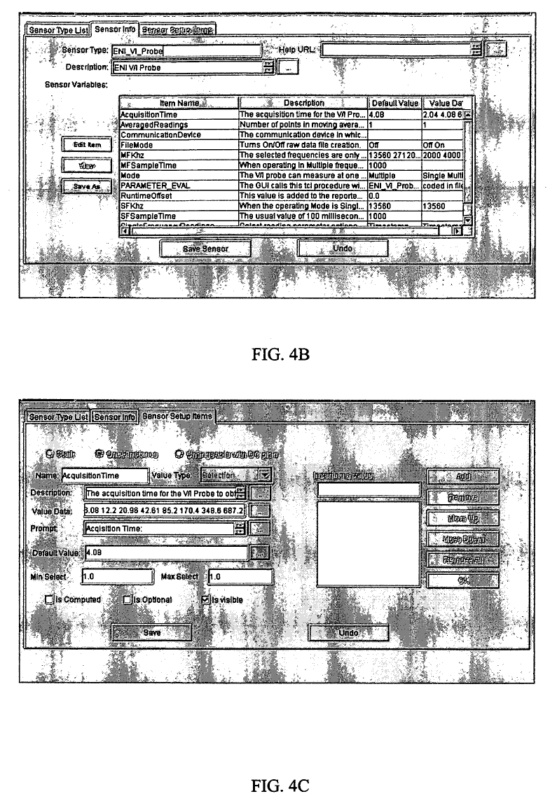

FIGS. 4A-4C show exemplary views of sensor configuration panels in accordance with one embodiment of the present invention. For example, sensor configuration panels can be accessed by a user using a selection item such as a button, a tab, a list item, a menu item, and/or a visual descriptor. The user can use sensor configuration panels to create a new sensor type when a new sensor interface is developed or a new process tool or process module requires configuration. The APC system can comprise a pre-defined list of sensor types that are supported by the APC software. For example, changes can be made at a customer site after installation, before starting to run the process equipment, or as a re-configured example set from the factory. The sensor configuration process can include a complete definition of all the input and output parameters to be used later when creating a sensor instance or when configuring an instance of a sensor at run-time in a data collection plan. The parameters created in this setup step can be displayed later in other sensor information screens and data collection plan screens.

In FIG. 4A, a sensor type list panel is shown. In FIG. 4B, a sensor information panel is shown. In FIG. 4C, a sensor setup panel is shown. For example, a user can navigate between panels using buttons and/or tabs, and a user can enter and/or change items using input fields, buttons, tabs, menus, and lists. Using an edit item, the user can select an existing sensor in order to modify the related parameters for that sensor. Using a save as item, a user can create a new type of a sensor based on an existing sensor type.

For example, an OES sensor can be a type of sensor, and a VI probe can be another type of sensor. These are generic definitions for types of sensors. A sensor type includes all of the variables that are needed to set up a particular kind of sensor at run time. These variables can be static (all sensors of this type have the same value), configurable by instance (each instance of the sensor type can have a unique value), or configurable by the data collection plan (each time the sensor is activated at run time, it can be given a different value). For example, a “configurable by instance” variable is the sensor IP address. This address varies by instance (for each process chamber) but does not vary from run to run. A “configurable by data collection plan” variable is the list of harmonic frequencies. These are configured by wafer based on the context information. Wafer context information includes tool ID, module ID, slot ID, recipe ID, cassette ID, start time and end time.

As an example, etch-related sensors are shown, but this is not required for the invention. Alternately, other and/or additional sensor types and process module types can be shown. For example, deposition modules, diffusion modules, cleaning modules, transfer modules, measurement modules, and other types of semiconductor processing modules can be used along with their associated sensors.

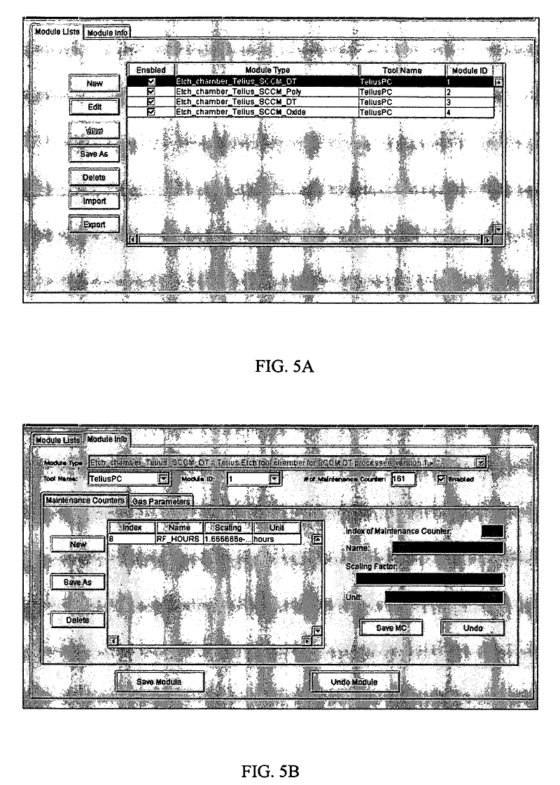

FIGS. 5A-5C show exemplary views of module configuration panels in accordance with one embodiment of the present invention. For example, module configuration panels can be accessed by a user using a selection item such as a button, a tab, a list item, a menu item, and/or a visual descriptor. The user can use module configuration panels to create a new process module type when a new module interface is developed or a new process tool or process module requires configuration. The APC system can comprise a pre-defined list of module types and module instances that are supported by the APC software. For example, changes can be made at a customer site after installation, before starting to run the process equipment, or as a re-configured example set from the factory. The module configuration process can include a complete definition of all the input and output parameters to be used later when creating a module instance or when configuring an instance of a module at run-time in a data collection plan. The parameters created in this setup step can be displayed later in other module information screens and data collection plan screens.

In FIG. 5A, a module list panel is shown. In FIG. 5B, a first module information panel is shown. In FIG. 5C, a second module information panel is shown. For example, a user can navigate between panels using buttons and/or tabs, and a user can enter and/or change items using input fields, buttons, tabs, and lists. Using an edit item, the user can select an existing process module in order to modify the related parameters for that module. Using a save as item, a user can create a new type of a process module based on an existing module. Using a delete item, a user can delete an existing module instance.

As an example, etch-related process modules are shown, but this is not required for the invention. Alternately, other and/or additional process module types can be shown. For example, deposition modules, diffusion modules, cleaning modules, transfer modules, measurement modules, and other types of semiconductor processing modules can be used. In addition, the GUI allows users to configure and use process module simulators for off-line analysis.

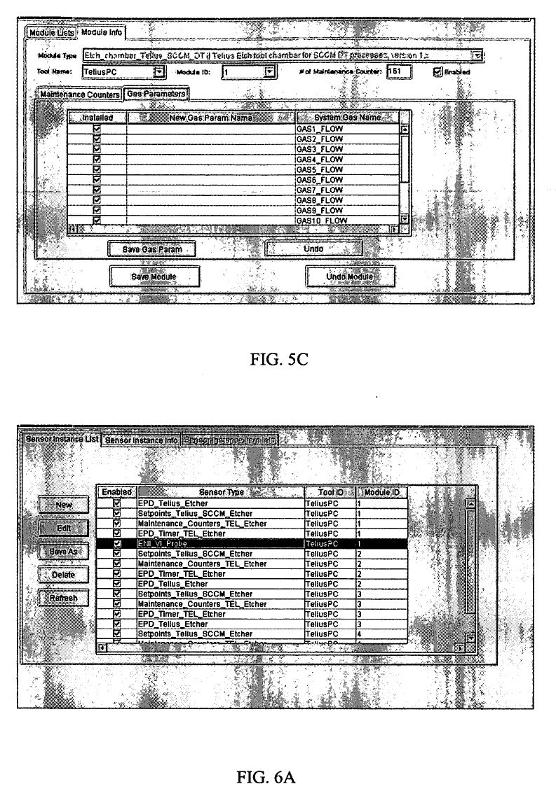

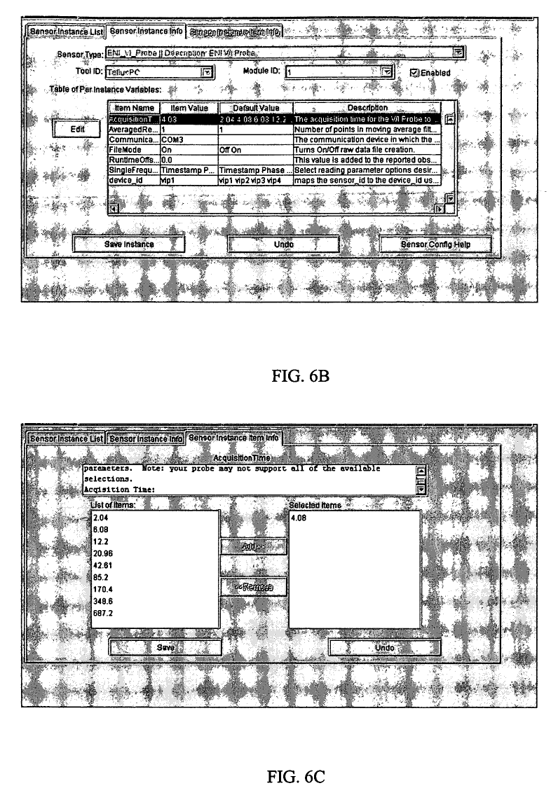

FIGS. 6A-6C show exemplary views of sensor instantiation panels in accordance with one embodiment of the present invention. For example, sensor instantiation panels can be accessed by a user using a selection item such as a button, a tab, a list item, a menu item, and/or a visual descriptor. The user can use sensor instantiation panels to create a new sensor instance when a new sensor instance is required or a new sensor instance is require for a process tool or process module. There can be many instances of the same sensor type. For example, a sensor instance can correspond to a specific piece of hardware and connects a sensor type to a tool or process module

The APC system can comprise a pre-defined list of sensor instances that are supported by the APC software. For example, changes can be made at a customer site after installation, before starting to run the process equipment, or as a re-configured example set from the factory. The sensor configuration process can include a complete definition of all the input and output parameters to be used later when creating a sensor instance or when configuring an instance of a sensor at run-time in a data collection plan. The parameters created in this setup step can be displayed later in other sensor information screens and data collection plan screens.

In FIG. 6A, a sensor instance list panel is shown. In FIG. 6B, a sensor instance information panel is shown. In FIG. 6C, a sensor instance item panel is shown. For example, a user can navigate between panels using buttons and/or tabs, and a user can enter and/or change items using input fields, buttons, tabs, and lists. Using an edit item, the user can select an existing sensor instance in order to modify the related parameters for that sensor instance. Using a save instance item, a user can create a new sensor instance.

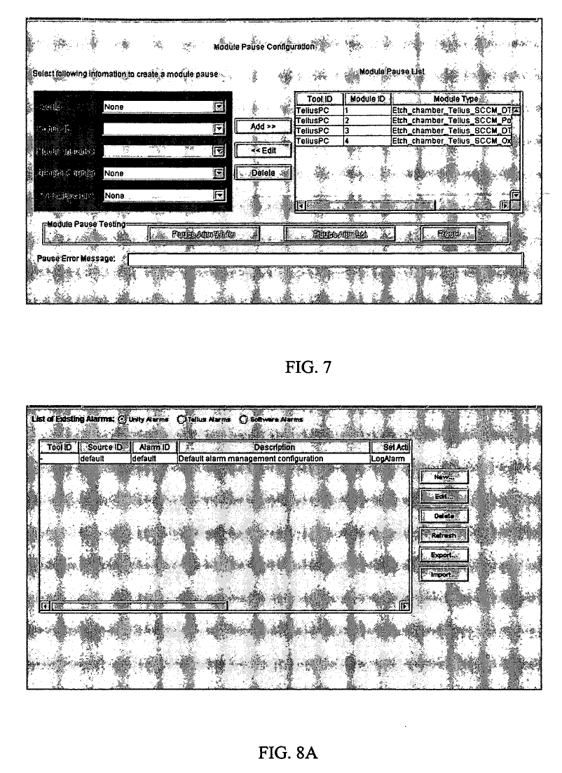

FIG. 7 shows an exemplary view of a module pause configuration panel in accordance with one embodiment of the present invention. For example, module pause configuration panels can be accessed by a user using a selection item such as a button, a tab, a list item, a menu item, and/or a visual descriptor. The authorized user can use module pause configuration panels to create a new module pause instance when a new module pause instance is required or a new module pause is require for a process tool or process module.

A module configuration panel such as module pause configuration panel can comprise an information selection area, a module pause testing area, a module pause message area, and a module pause list area. Drop-down lists help a user configure the module pause.

Module pause configuration panel can be used by a user who has a specific level of authorization, such as a process engineer. A user can configure the pause actions using analysis plans and strategies. For example, a user can determine which maintenance counter is used for a module pause when an alarm occurs. Typically, there can be only one module pause configured for each module. User can select one of the general maintenance counters to do the module pause. A maintenance counter can be configured to perform a module pause function based on any measurable parameter. A user can configure the tool ID field, the module ID field, the module Instance field. (indicating a name of a module), and the module counter fields using drop-down lists, for example. Only when the module instance field is enabled can a module instance list be shown in the drop down box. In addition, a list of general counter information can be listed in the drop down box that combine name and index of each maintenance counter. Using the add button, a user can add selected information to the table. Using the Remove button, a user can delete selected information from the table. A Pause Error Message display can provide error message feedback to the user.

Module pause can become effective at the end of current wafer or the end of current lot. A number of alarms can be used to trigger a tool pause, for example, a tool alarm, a fault detection alarm, or software internal errors.

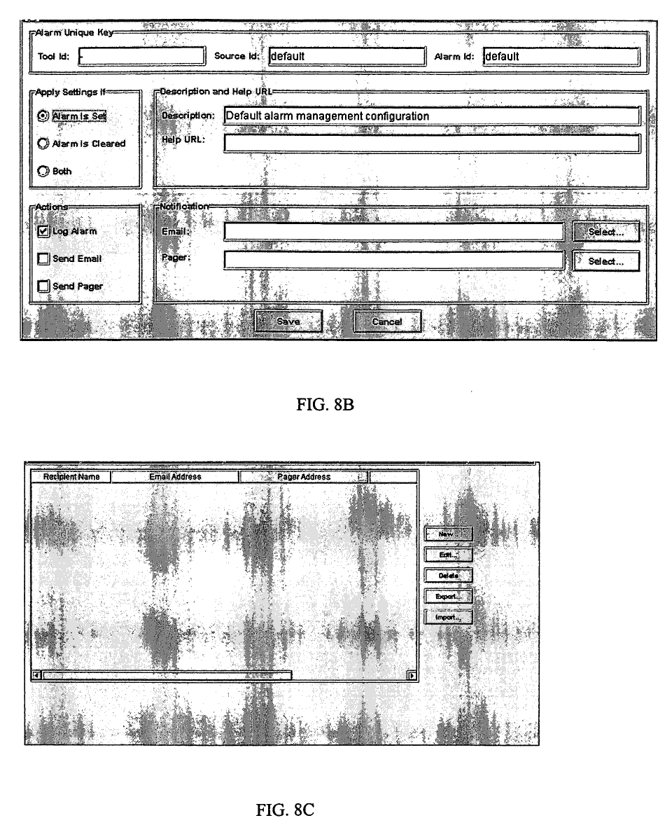

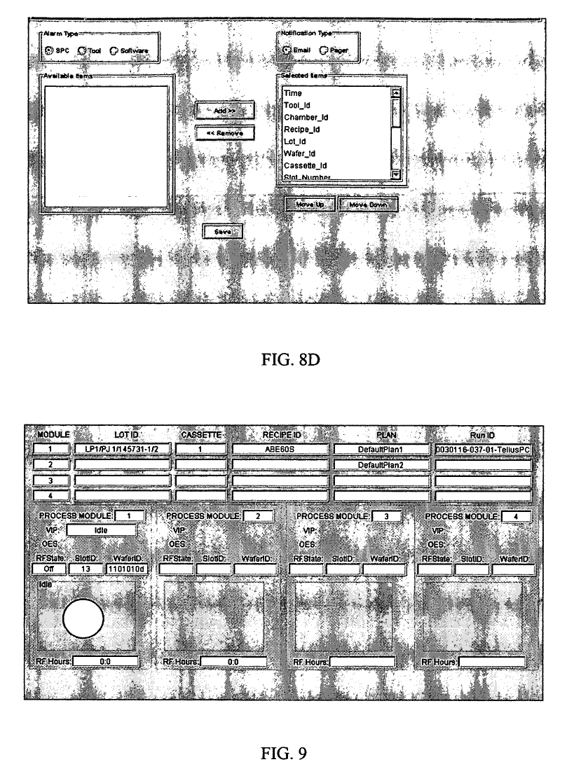

FIGS. 8A-8D show exemplary views of alarm configuration panels in accordance with one embodiment of the present invention. For example, alarm configuration panels can be accessed by a user using a selection item such as a button, a tab, a list item, a menu item, and/or a visual descriptor. The user can use alarm configuration panels to create a new alarm when a new alarm is required or a new alarm is require for a process tool or process module. For example, alarms can comprise tool alarms, software alarms, and process related alarms.

The APC system can comprise a pre-defined list of alarms that are supported by the APC software. For example, changes can be made at a customer site after installation, before starting to run the process equipment, or as a re-configured example set from the factory. The alarm configuration process can include a complete definition of all the input and output parameters to be used later when creating an alarm instance. The parameters created in this setup step can be displayed later in other alarm information screens and data collection plan screens.

In FIG. 8A, an alarm list panel is shown. In FIG. 8B, an alarm setup panel is shown. In FIG. 8C, a recipient setup panel is shown. In FIG. 8D, a message setup panel is shown. For example, a user can navigate between panels using selection items, and a user can enter and/or change items using input fields, buttons, tabs, and lists. Using an edit item, the user can select an existing alarm in order to modify the related parameters for that alarm. Using a save item, a user can create a new alarm.

FIG. 9 shows an exemplary view of a tool status panel in accordance with one embodiment of the present invention. For example, a tool status panel can comprise one or more of the following information panel elements: module ID, lot ID, cassette, recipe ID, plan, run ID, process module, VIP, OES, RF state, process module status, and RF hours fields. For example, information about the wafer currently in the process chamber can be displayed where: wafer ID can be the name for the current wafer being processed, slot ID can be the slot in the cassette for the wafer, lot ID can be the ID of the lot to which the wafer in the chamber belongs; cassette can be the ID of the cassette from which the wafer came; recipe ID can be the ID of the recipe for the current wafer; plan can be the name of the data collection plan executed on the current wafer.

A user can also use a tool status screen to view sensor status. For example, a VIP field can be used to display the current state of a VIP probe. An OES field can be used to display the current state of an OES sensor in the process module. Valid values for the VIP probe and OES sensor can include: Idle for an inactive probe/sensor, Ready for a probe/sensor that has been initialized and is ready to record, and Recording for a probe/sensor that is recording OES sensor or VIP probe data. The field will be blank if no sensor is installed for the process module. RF State is the current RF state. Valid values are On and Off. When RF is On, the wafer picture is highlighted, otherwise the wafer picture is gray. The Slot ID represents the cassette slot from which the wafer came. Wafer ID is the scribe of the current wafer in the process module. If the user has not defined the wafer ID to be the wafer scribe, then the tool-assigned wafer number is displayed.

Real time process module status can also be shown graphically in a sub panel, and the status of the process module can be displayed in the upper left corner of the process module graphic. For example, valid values can be: idle when the process module is empty; active when a wafer is in the process module but the recipe has not started; processing when a wafer is in the process module and the recipe has started; and complete when a wafer is in the process module and the recipe has completed. A picture (i.e.; a circle) can be displayed when a wafer is in the process module. For example, the circle can be one color when RF is on, and another color when RF is off. The number displayed as a part of the picture represents the following, first digit: the cassette from which the wafer came; second and third digits: the slot from which the wafer came. RF Hours is the cumulative RF hours for the process module.

To view additional information on process module status, a user can use the graphical display (circle) on the desired process module in the tool status screen as a selection item, or use a selection item on a control panel (not shown), or use a selection item on a menu. The process module status screen displays data about a specific process module.

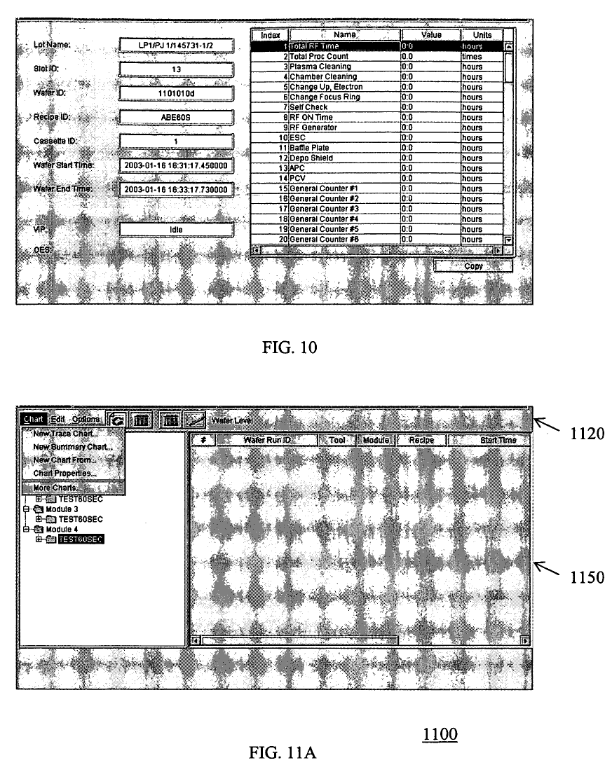

FIG. 10 shows a simplified view of a process module status panel in accordance with one embodiment of the present invention. For example, current information can be displayed for the selected process module in the panel, and the panel can comprise one or more of the following panel elements: a lot name field, a slot ID field, a wafer ID field, a recipe ID field, a cassette ID field, a wafer start time field, a previous wafer end time field, a VIP field, an OES field, a name field, a value field, and a unit field. For example, a lot name field can include the name of the lot to which the wafer in the process module belongs; a slot ID field can show the cassette slot from which the wafer came; a wafer ID field can display the scribe of the current wafer; a recipe ID field can show the name of the current or the last recipe run in the module; a cassette ID field can display the ID of the cassette from which the wafer came; and a recipe ID field can include the ID of the recipe for the current wafer. In addition, a wafer start time field can display the date and time at which a recipe start step was initiated; a previous wafer end time field can show the date and time at which a recipe end step was initiated; a VIP field can display the current state of the VIP probe for the process module; an OES field can include the current state of the OES sensor for the process module, where valid values for the VIP probe and OES sensor can include idle, ready, and recording; an index field can show the index of maintenance counters 1˜xx; a name field shows the parameter name; a value field shows the value of the parameter/maintenance counter; and a unit field displays the units, such as RF hours.

The process module panel can display the current status in real time. For example, when a wafer is not in the process module, the fields can be blank. Alternately, when a wafer is not in the process module, the fields can display data for the last wafer processed in the module. If the user has not defined the wafer ID for the wafer scribe, then the tool-assigned wafer number can be displayed.

In an alternate embodiment, a status screen can be accessed from a navigation tree. For example, a tool name field can be shown in a tree structure, and a tool status screen can be activated by selecting this field. In addition, a module name field can be shown in a tree structure, and a module status screen can be activated by selecting this field. Alternately, status screens can be accessed using a navigation bar.

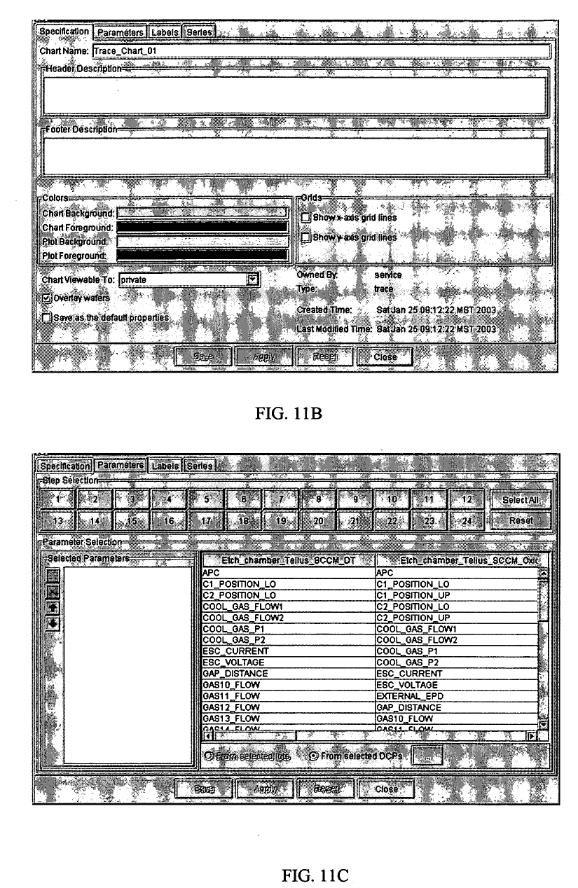

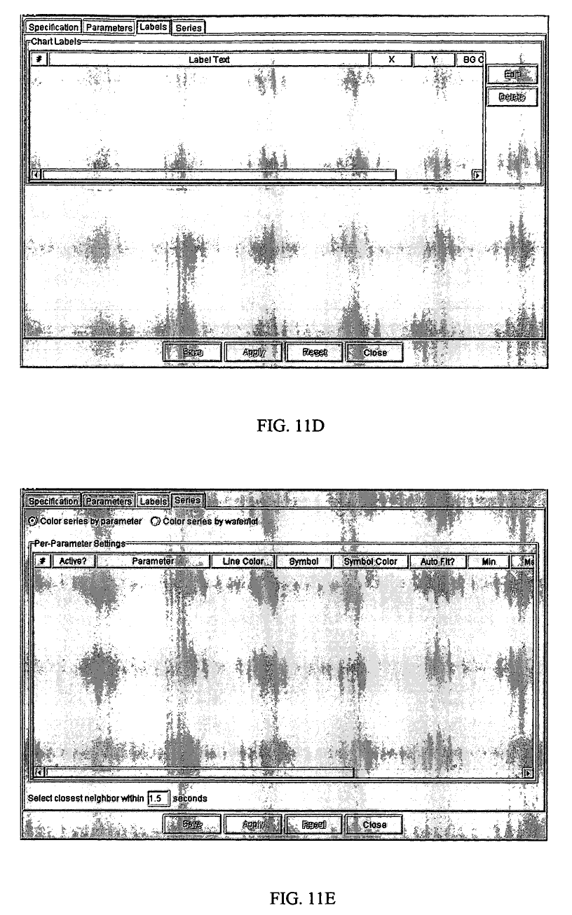

FIGS. 11A-11E show exemplary views of chart selection panels in accordance with one embodiment of the present invention. Charts can be used for displaying real time status and historical status information. In the illustrated embodiment, charts screen 1100 comprises a selection bar 1120 and an information panel 1150. An information panel can comprise a chart selection tree sub panel and a list sub panel. For example, a chart selection tree can be organized using a tool, module, and recipe hierarchy; selections in the tree can be multiple and non-adjacent; the columns in the wafer/lot list table can be dragged and rearranged; clicking on a column header will sort the table by that column; multiple wafers/lots in the table can be selected; a chart is a reusable template; and a chart is not tied to any specific wafers.

Data collected from the tool and sensors by means of the APC system can be displayed to a user using different types of charts. For example, a trace chart can be used to display trace parameter data. In addition, a summary chart can be used to display summary parameter data for one or more wafers for one or more steps. Wafer summary calculations can be calculated from raw data gathered from the tool. The database can store raw data separately, and the raw data is not modified when summary calculations are performed. In addition, summary statistics are generally calculated by step from raw time series data and include at least one of the following items: minimum, maximum, mean, range, standard deviation, high spike count (HSC), and low spike count (LSC). The standard deviation can only be calculated if there are at least two data points. In addition, a trace chart can be used to display raw parameter data for one or more wafers and one or more steps.

Using a selection item in the selection bar, an edit drop down list can be displayed. This short cut menu can include a select all item which selects all wafers or lots listed in the table. The options drop down menu can include at least one of: a list at wafer level item, a list at lot item, a node preferences item which displays the different options for nodes on the charts navigation tree; and a refresh tree item that updates the navigation tree.

In addition, a chart properties selection item can be used to create and edit the properties of a particular chart. Chart property GUI panels are illustrated in FIGS. 11B-11E, and can be used to configure new trace charts and new summary charts. For example, chart property GUI panels can include a specification panel, a parameters panel, a labels panel, and series panel. A user can navigate between charting GUI panels using selection items such as tabs, boxes, lists, and menus.

SPC charts are another type of chart that is supported by the APC system and software. SPC charts can be used to monitor a selected process after all wafer data have been collected. For example, SPC charts can be used to monitor a process to determine if the mean and distribution change over time. After data are collected, summary data can be calculated and plotted on a chart as one point per wafer. The APC software summarizes data by step summary parameters. After reviewing this historical data, the engineer sets the initial control limits and decides which run rules to apply to the process. After observing the process, the engineer may reset the limits as known drifts occur.

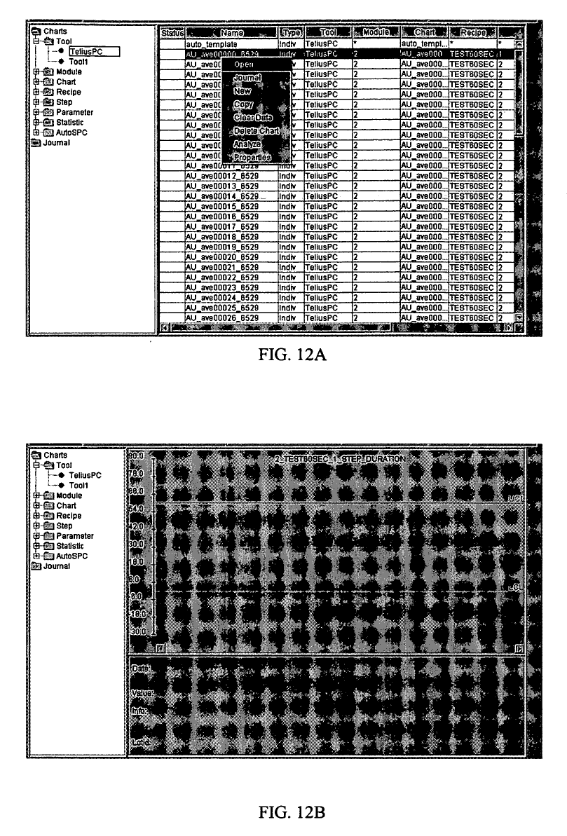

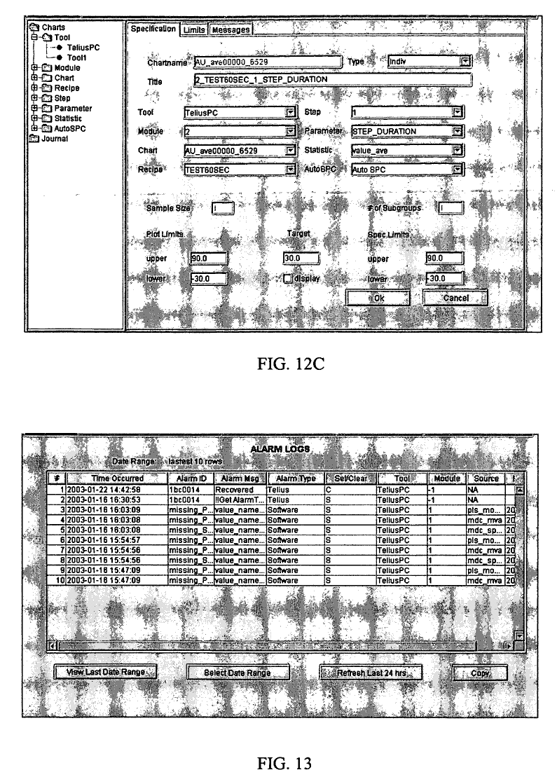

FIGS. 12A-12C show exemplary views of SPC chart panels in accordance with one embodiment of the present invention. SPC chart GUI panels provide a means for creating SPC charts of process parameters, editing SPC chart configurations, and establishing SPC alarms that generate email warnings and/or pager messages.

For example, SPC charts can show parametric data summarized by step, and this step summary data can be calculated using data saved to the database with a data collection plan. Summary data information can also be used for multivariate analysis. The method used for feeding summary data into models defines the conditions under which summary data for one or more parameters for a step is input to the principal component analysis (PCA) model or partial least squares (PLS) model for multivariate analysis. The model output parameters then can be sent to SPC charts.

SPC charts can be used for displaying real time status and historical status information. For example, SPC chart violations can be used to trigger an alarm condition in real time.

In FIG. 12A, an SPC chart selection GUI panel is shown. The SPC chart selection panel comprises a charts navigation sub panel, a selection list sub panel, and a selection item list. For example, a charts navigation window can provide a means for a user to browse through the available charts, and folders with nodes can be provided in the navigation window. In addition, the selection item list can be a short cut menu or a drop down list and can be used to open a SPC chart, examine a journal, create a new SPC chart, copy an existing SPC chart, clear data, delete a SPC chart, analyze a SPC chart, and view/edit properties of a SPC chart. Additional selection items can be used to view/edit/enter specification information, limit information, and message information.

An exemplary SPC graph is shown is FIG. 12B. Although a single chart is shown this is not required for the invention; the APC system and software can display more than one chart at a time.

The APC system and software provides GUI panels for creating, editing, viewing SPC charts. For example, an SPC chart can be a Shewhart control chart that comprises at least one of: a mean, a minimum, a maximum, range of a process parameter versus time, and range of a process parameter versus sample number. Example charts can comprise the following features: a centerline—a horizontal line representing the mean value of the plotted parameter expected under normal, or “in control” processing conditions; an Upper Control Limit (UCL) and Lower Control Limit (LCL), where the UCL and LCL are horizontal lines that lie above and below the mean, respectively, and their values are set at +/−3 sigma, where sigma is the standard deviation from the mean (under normal conditions, 99.73% of the data points should fall within the upper and lower control limits); an Upper Warning Limit (UWL) and Lower Warning Limit (LWL).

One of the folders shown on the navigation menu is an “AutoSPC” folder. The folder contains a list of SPC charts that have been automatically configured by the APC system and software. In addition, the APC system and software provides GUI panels for editing, viewing, analyzing, enabling, disabling, and deleting SPC charts that have been automatically generated. For example, an AutoSPC field can be used to enable or disable the auto-configuration feature.

During installation, a template SPC plan is created and associated with one or more AutoSPC post-run strategies. GUI screens are provided to allow the template SPC plan to be edited. After installation, the APC system can be automatically configured for fault detection using SPC run-rule evaluation. Each of the available summary statistics (average, standard deviation, minimum, maximum, etc.) for each of the available trace parameters is a candidate for automatic SPC chart creation. Tool level trace parameters can comprise measured and reported values of process variables, such as, for etch systems, gas flow rates, RF power, RF reflected power, peak-to-peak voltage, pressure, temperature, etc. Mapping of the available parameters and statistics to enabled parameters is based on the installer's or operator's recommendations and the process specific requirements. Also, auto configuration can be re-run at any time after installation if the selection of parameters changes.

After installation, at run-time, as new recipes are encountered, SPC charts can be automatically created for tracking controlled and non-controlled enabled parameters during process steps, such as RF steps in an etch system. Controlled parameters comprise trace parameters that have a setpoint. These parameters are controlled on the tool to within some tolerance based on a percentage deviation from the setpoint or absolute deviation from setpoint. For a given recipe and process step, some controlled parameters can have setpoints that are zero. In this case, the percentage deviation from setpoint technique cannot be used because it would require division by zero. Non-controlled parameters comprise trace parameters without setpoints. The values of these parameters typically depend on the setpoints of the controlled parameters. After a configurable number of wafers have accumulated in each automatically created chart and if the auto calculation flag is enabled for that parameter, the upper and lower control limits can be automatically calculated and the chart enabled for alarms based on SPC run rule evaluation.

FIG. 13 shows an exemplary view of an alarm logs panel in accordance with one embodiment of the present invention. For example, when a tool alarm occurs, an entry is written to the alarm table in the database. A tool alarm can occur when a processing tool, processing module, and/or processing sensor experiences a problem. In addition, when a processing alarm occurs, an entry is written to the alarm table. A processing alarm can occur when a measured process parameter is outside established limits. Also, when a software alarm occurs, an entry is written to the alarm table. A software alarm can occur when disk space reaches an established limit. Likewise, when the system recovers from an alarm, an entry is written to that table. To view the contents of this file, a user can use an alarm logs GUI panel.

An alarm logs panel can comprise at least one of: a time occurred field which can show the date/time that the alarm occurred, or the date/time that the process tool recovered from the alarm; an alarm ID field showing the system-assigned alarm ID. (i.e. the APC system can assign specific ID numbers to specific alarms); an alarm message field that shows information regarding the severity of the alarm and the current state of the alarm; an alarm type field; a set/cleared field; a tool field that shows the unique name assigned to the tool (i.e. etcher, deposition, cleaning); In addition, a message field can contain either a description of the alarm, a status, and an alarm severity.

A refresh selection item enables a user to update the panel to show the latest alarms. The panel only refreshes when the button is clicked. A range selection item enables a user to view the alarms from the last date range that was selected. The select range selection item enables a user to obtain the alarms for a selectable time period.

A status panel such as an alarm logs panel provide a means for monitoring problem status, and an alarm logs panel can be used to alert a user to a problem in real time and can be used to track a problem using historical data. SPC chart violations can be sent to an alarm manager, which can post the violations as alarms in an alarm log, can send messages (i.e., trigger emails, pages) and can halt processing (i.e., send a tool pause command).

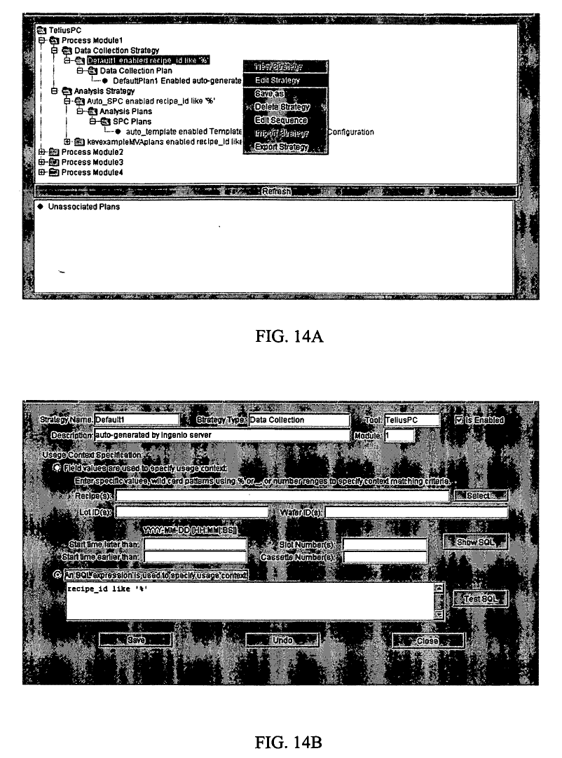

FIGS. 14A-14B show exemplary views of data collection strategy panels in accordance with one embodiment of the present invention. In the illustrated embodiment, a navigation tree is shown, but this is not required for the invention. Alternately, other selection means can be used such as selection tabs, lists, or buttons. The first level shown in FIG. 14A is the tool level, but this is not required for the invention. Alternately, a system level or other higher-level group can be shown. For example, a tool level can be associated with an etching tool, a deposition tool, a cleaning tool, a transfer tool, or other semiconductor processing tool. In an alternate embodiment, selection means can be provided that allow a user to display one or more tool status panels from the navigation tree using a mouse button or a sequence of keystrokes.

The next level shown is a process module level. A user can open a tool level folder to display the status for a process module level. For example, FIG. 14A shows an opened tool level folder labeled as “TeliusPC” and four process module folders labeled as “Process Module 1” through “Process Module 4”. A user can open a process module folder to display the status for the data collection strategies associated with a particular process module. In an alternate embodiment, selection means can be provided that allow a user to display one or more module status panels from the navigation tree using a mouse button or a sequence of keystrokes.

The next level shown is a data collection strategy level. A user can open a process module level folder to display the status for a strategy level. For example, FIG. 14A shows an opened process module level folder labeled as “Process Module 1” and two strategy folders labeled as “Data Collection Strategy” and “Analysis Strategy”. A user can open a strategy folder to display the status for the context associated with a particular strategy. A “Data Collection Strategy” folder can be opened to display a list of data collection strategies. In the illustrated embodiment, a single data collection strategy is shown along with the context associated with the data collection strategy. Wafer context is used to invoke the specific data collection strategies and plans that are required for a particular item, such as a wafer. Wafer context can comprise at least one of system id, tool id, module id, slot id, recipe id, lot id, batch id, cassette id, start time, and stop time.

A short cut menu can be provided that allows a user to create a new strategy, edit a strategy, save a strategy, delete a strategy, edit a sequence, import a strategy, and export a strategy.

A data collection strategy setup panel is shown in FIG. 14B. The APC system and the APC software auto-generates at least one default data collection strategy when the APC system and APC software is configured. The auto-generated data collection strategy can be used to operate the system or serve as an example for a process engineer to use to setup a different data collection strategy.

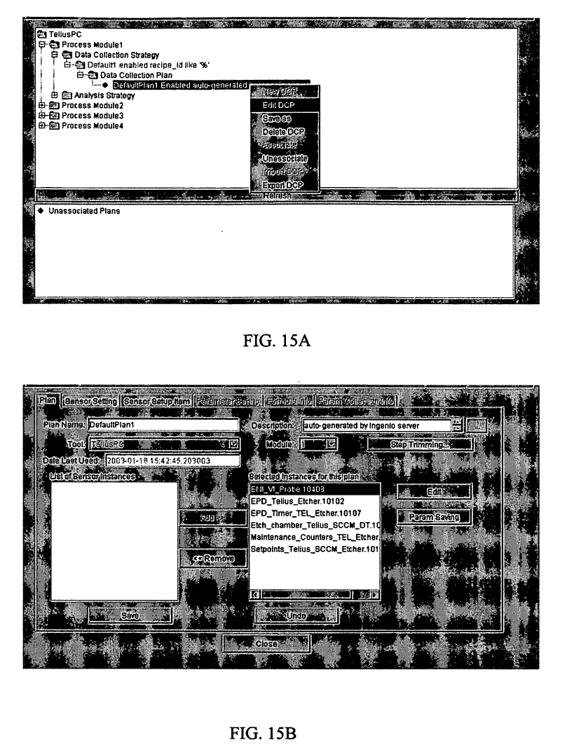

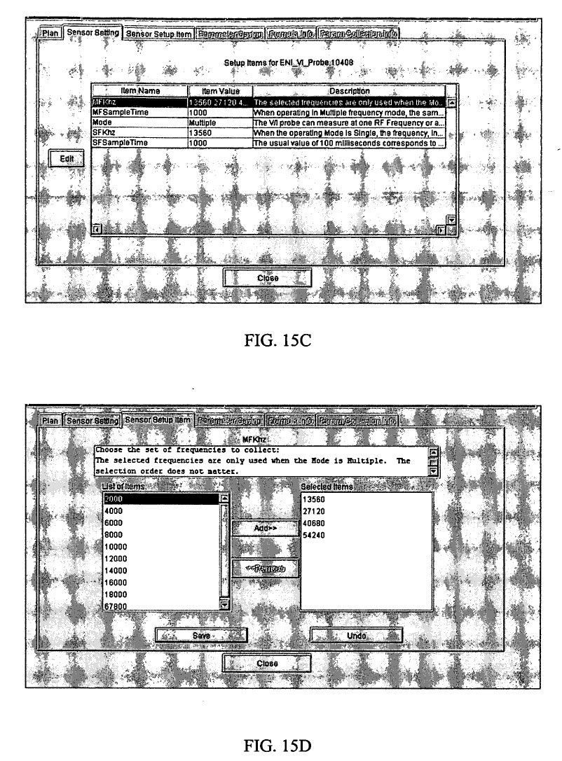

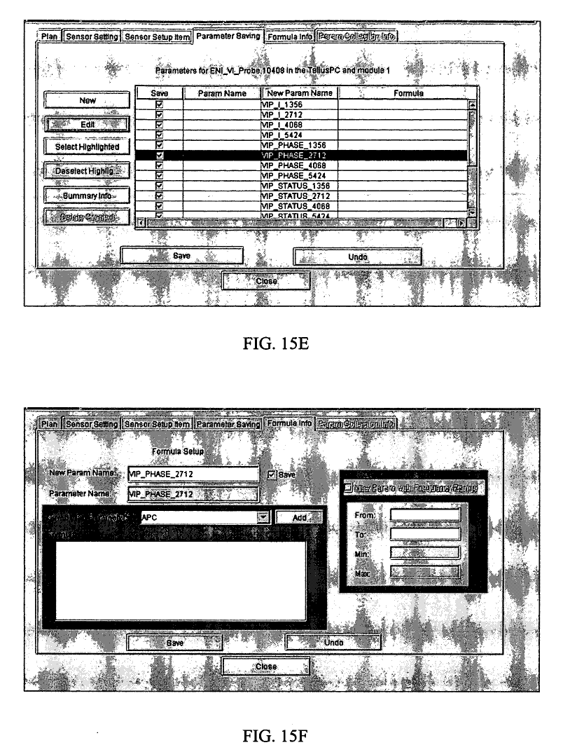

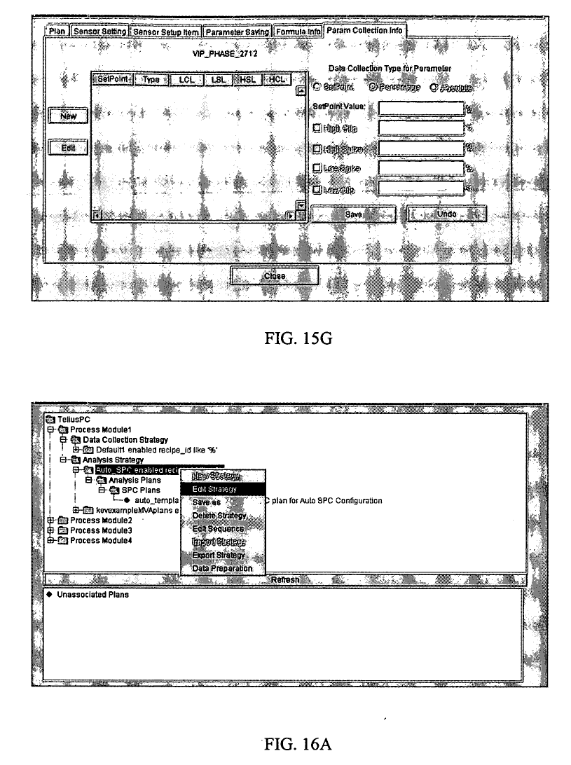

FIGS. 15A-15G show exemplary views of data collection plan (DCP) panels in accordance with one embodiment of the present invention. For example, a DCP can be used to determine which data is collected and how the data is collected. In FIG. 15A, a navigation tree is shown, but this is not required for the invention. Alternately, other selection means can be used such as selection tabs, lists, or buttons. A drop-down list is also shown in that allows a user to create a new DCP, edit a DCP, save a DCP, delete a DCP, associate a DCP, unassociated a DCP, import a DCP, and export a DCP. Alternately, other selection means can be used such as selection tabs, menu items, or buttons.

The APC system and the APC software auto-generates at least one default DCP when the APC system and APC software is configured. The auto-generated DCP can be used to operate the system or serve as an example for a process engineer to use to setup a different DCP.

A particular data collection plan folder can be opened to display a “Data Collection Plan” folder that can be opened to display a data collection plan name. In FIG. 15B, a single data collection plan name “DefaultPlan1” is displayed, and selection means are available that allow a user to display a data manager screens as shown in FIGS. 15C-15G. For example, a selection list can be displayed using a mouse button or a sequence of keystrokes.

A data collection strategy has an associated DCP that determines a set of sensor instances; determines how the sensor instances are configured, determines which parameters should be collected, and describes how the parameters are to be processed with respect to spike counting, step trimming, high clip, low clip, and limits.

There can be multiple data collection strategies that match a run context. The user determines the order of the strategies within a specific context by moving the strategies up or down on the list. When the time comes for the data collection strategy to be selected, the software starts at the top of the list and goes down the list until it finds the first data collection strategy that matches the requirements determined by the context. This first data collection strategy then points to a single DCP that is used.

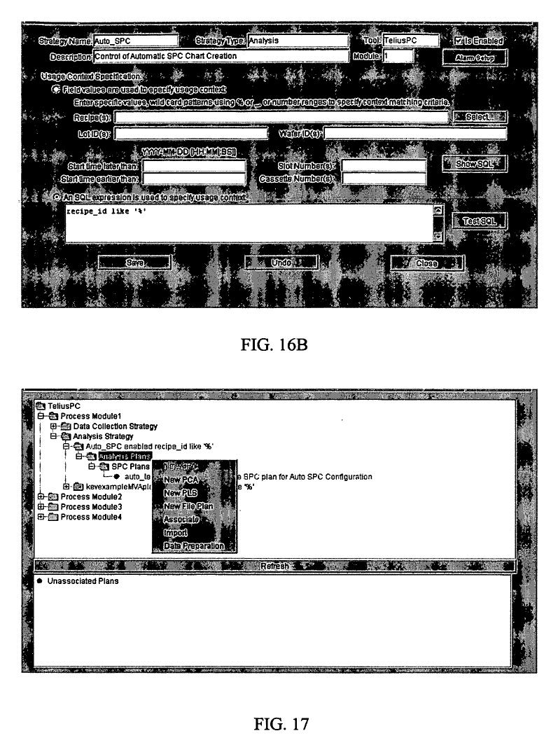

FIGS. 16A-16B show exemplary views of analysis strategy panels in accordance with one embodiment of the present invention. In the illustrated embodiment, a navigation tree is shown, but this is not required for the invention. Alternately, other selection means can be used such as selection tabs, lists, or buttons.

The first level shown in FIG. 16A is the tool level, but this is not required for the invention. Alternately, a system level or other higher-level group can be shown. For example, a tool level can be associated with an etching tool, a deposition tool, a cleaning tool, a transfer tool, or other semiconductor processing tool. In an alternate embodiment, selection means can be provided that allow a user to display one or more tool status panels from the navigation tree using a mouse button or a sequence of keystrokes.

The next level shown is a process module level. A user can open a tool level folder to display the status for a process module level. For example, FIG. 16A shows an opened tool level folder labeled as “TeliusPC” and four process module folders labeled as “Process Module 1” through “Process Module 4”. A user can open a process module folder to display the status for the analysis strategies associated with a particular process module. In an alternate embodiment, selection means can be provided that allow a user to display one or more module status panels from the navigation tree using a mouse button or a sequence of keystrokes.

One process module sublevel can be an analysis strategy level. A user can open a process module level folder to display the status for an analysis strategy level. For example, a user can open an analysis strategy folder to display the status for the context associated with a particular analysis strategy. In the illustrated embodiment, a single analysis strategy “AutoSPC” is shown along with the context associated with the analysis strategy. Wafer context can be used to invoke the specific analysis strategies and plans that are required for a particular item, such as a wafer. Wafer context can comprise at least one of system id, tool id, module id, slot id, recipe id, lot id, batch id, cassette id, start time, and stop time.

A drop-down list is provided that allows a user to create a new strategy, edit a strategy, save a strategy, delete a strategy, edit a sequence, import a strategy, and export a strategy.

An analysis strategy setup panel is shown in FIG. 16B. The APC system and the APC software auto-generates at least one default analysis strategy when the APC system and APC software is configured. The auto-generated analysis strategy can be used to operate the system or serve as an example for a process engineer to use to setup a different data collection strategy. For example, analysis strategies can be used to determine how the data are presented after wafers have finished processing. An analysis strategy can be associated with several analysis plans. A single analysis strategy can execute multiple analysis plans.

FIG. 17 shows an exemplary view of an analysis plan panel in accordance with one embodiment of the present invention. Analysis plans can include file output plans, SPC plans, PCA and PLS plans. Each plan is executed in the order in which it appears on the list. For example, analysis plans can be used to determine how the collected data is processed and presented. In FIG. 17, a navigation tree is shown, but this is not required for the invention. Alternately, other selection means can be used such as selection tabs, lists, or buttons. A drop-down list is also shown in that allows a user to create an analysis plan, edit an analysis plan, save an analysis plan, delete an analysis plan, associate an analysis plan, unassociated an analysis plan, import an analysis plan, export an analysis plan, and perform data preparation. Alternately, analysis plans can include other MVA plans, and FDC plans.

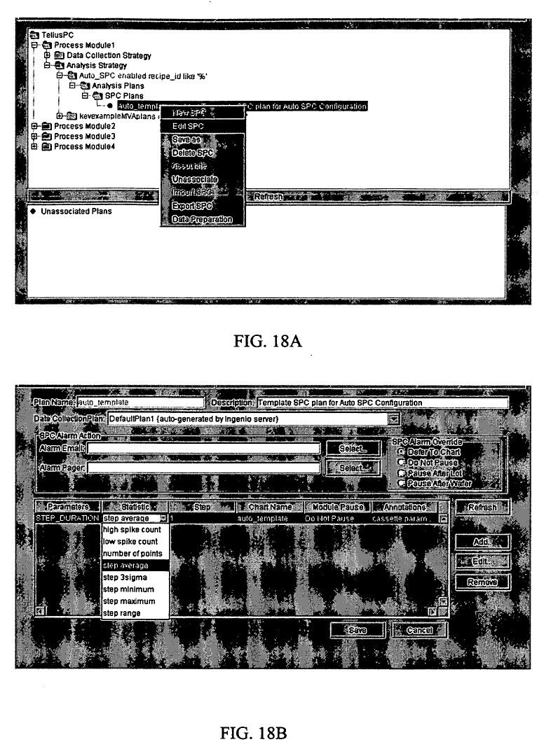

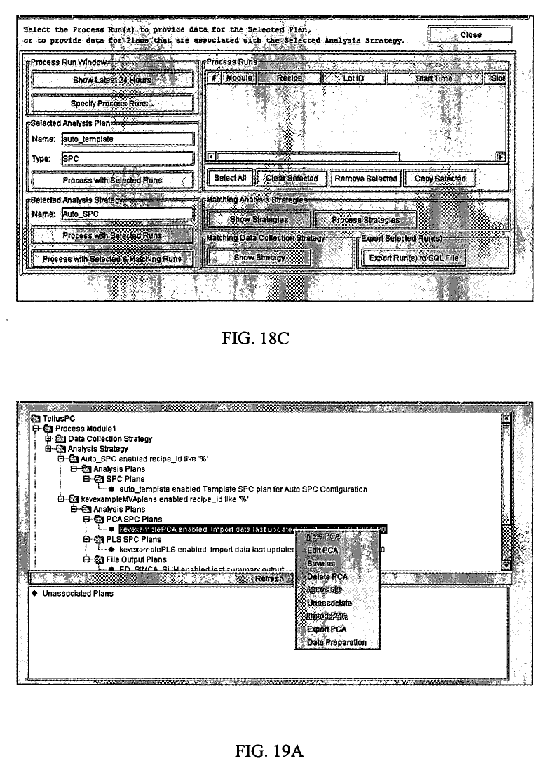

FIGS. 18A-18C show exemplary views of SPC plan panels in accordance with one embodiment of the present invention. For example, a SPC plan can be used to determine which data is presented in SPC charts and how alarms are to be processed. In FIG. 18A, a navigation tree is shown, but this is not required for the invention. Alternately, other selection means can be used such as selection tabs, lists, or buttons. A drop-down lists can be shown in that allow a user to create a new SPC plan, edit a SPC plan, save a SPC plan, delete a SPC plan, associate a SPC plan, unassociated a SPC plan, import a SPC plan, export a SPC plan, and perform data preparation. Alternately, other selection means can be used such as selection tabs, menu items, check boxes, or buttons.

The APC system and the APC software auto-generates at least one default SPC plan when the APC system and APC software is configured. The auto-generated SPC plans can be used to operate the system or serve as an example for a process engineer to use to setup a different SPC plan.

For example, the SPC plan panels can comprise at least one of: a plan name filed, a plan description field, a data collection plan name field a SPC alarm action field, and alarm information fields.

A SPC plan folder, such as “SPC plans” can be opened to display one or more specific SPC plans, such as “auto-template”. In FIG. 18A, a single SPC plan is displayed, and selection means are available that allow a user to display a SPC plan setup panels as shown in FIGS. 18B-18C. For example, these panels can be displayed using a mouse button or a sequence of keystrokes.

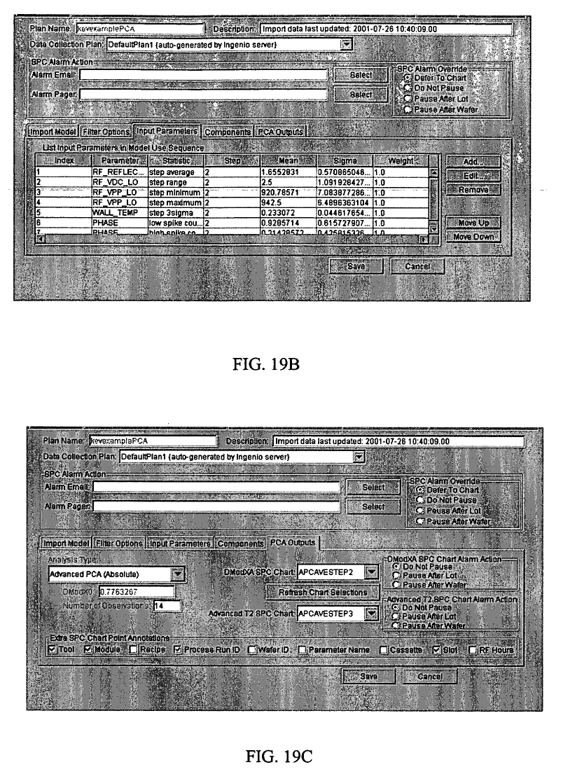

FIGS. 19A-19C show exemplary views of PCA plan panels in accordance with one embodiment of the present invention. For example, a PCA SPC plan can be used to determine which data is presented in PCA SPC charts and how alarms are to be processed. In FIG. 19A, a navigation tree is shown, but this is not required for the invention. Alternately, other selection means can be used such as selection tabs, lists, or buttons. A drop-down lists can be shown in that allow a user to create a new PCA SPC plan, edit a PCA SPC plan, save a PCA SPC plan, delete a PCA SPC plan, associate a PCA SPC plan, unassociated a PCA SPC plan, import a PCA SPC plan, export a PCA SPC plan, and perform data preparation. Alternately, other selection means can be used such as selection tabs, menu items, check boxes, or buttons.

The APC system and the APC software auto-generates at least one default PCA SPC plan when the APC system and APC software is configured. The auto-generated PCA SPC plans can be used to operate the system or serve as an example for a process engineer to use to setup a different PCA SPC plan.

For example, the PCA SPC plan panels can comprise at least one of: a plan name filed, a plan description field, a data collection plan name field a SPC alarm action field, an import/export sub panel, a parameters sub panel, a components sub panel, and a PCA outputs sub panel.

A PCA SPC plan folder, such as “PCA SPC plans” can be opened to display one or more specific SPC plans, such as an example PCA plan. In FIG. 19A, a single PCA SPC plan is displayed, and selection means are available that allow a user to display a PCA SPC plan setup panels as shown in FIGS. 19B-19C. For example, these panels can be displayed using a mouse button or a sequence of keystrokes.

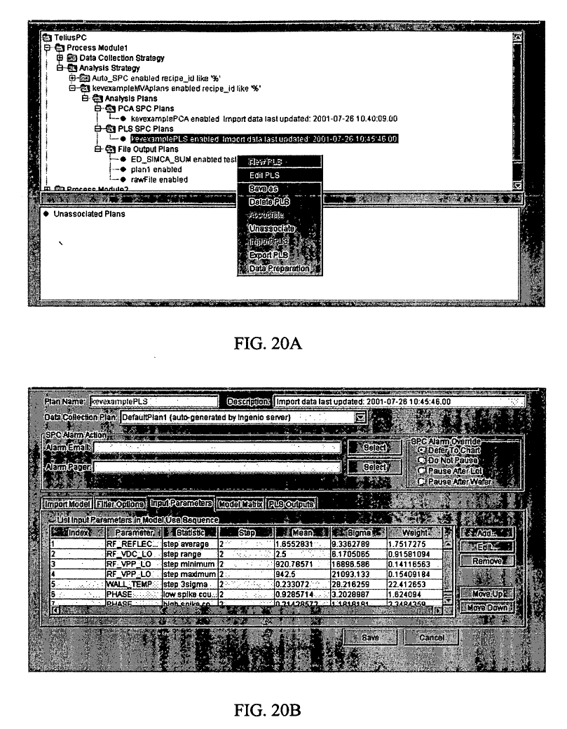

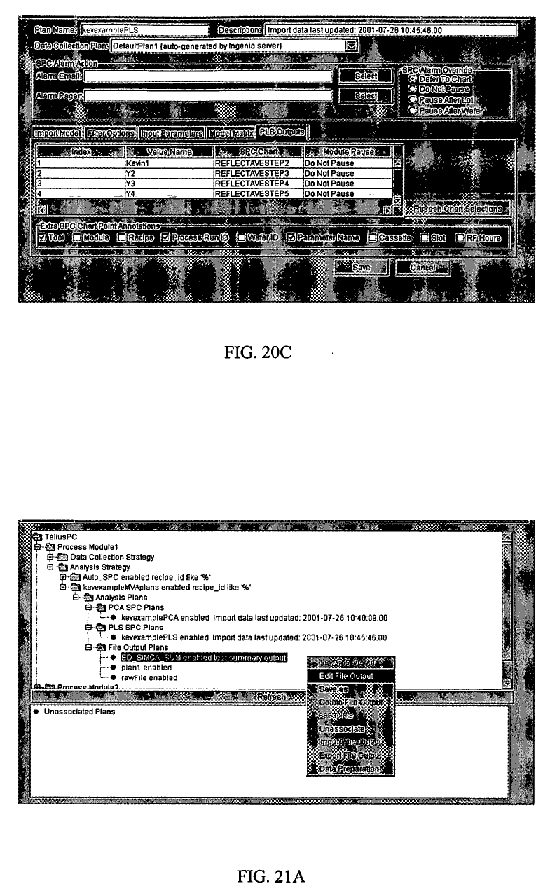

FIGS. 20A-20C show exemplary views of PLS plan panels in accordance with one embodiment of the present invention. For example, a PLS SPC plan can be used to determine which data is presented in PLS SPC charts and how alarms are to be processed. In FIG. 20A, a navigation tree is shown, but this is not required for the invention. Alternately, other selection means can be used such as selection tabs, lists, or buttons. A drop-down lists can be shown in that allow a user to create a new PLS SPC plan, edit a PLS SPC plan, save a PLS SPC plan, delete a PLS SPC plan, associate a PLS SPC plan, unassociated a PLS SPC plan, import a PLS SPC plan, export a PLS SPC plan, and perform data preparation. Alternately, other selection means can be used such as selection tabs, menu items, check boxes, or buttons.

The APC system and the APC software auto-generates at least one default PLS SPC plan when the APC system and APC software is configured. The auto-generated PLS SPC plans can be used to operate the system or serve as an example for a process engineer to use to setup a different PLS SPC plan.

For example, the PLS SPC plan panels can comprise at least one of: a plan name filed, a plan description field, a data collection plan name field a SPC alarm action field, an import/export sub panel, a filer options sub panel, an input parameters sub panel, a model matrix sub panel, and a PLS outputs sub panel.

A PLS SPC plan folder, such as “PLS SPC plans” can be opened to display one or more specific SPC plans, such as an example PLS plan. In FIG. 20A, a single PLS SPC plan is displayed, and selection means are available that allow a user to display a PLS SPC plan setup panels as shown in FIGS. 20B-20C. For example, these panels can be displayed using a mouse button or a sequence of keystrokes.

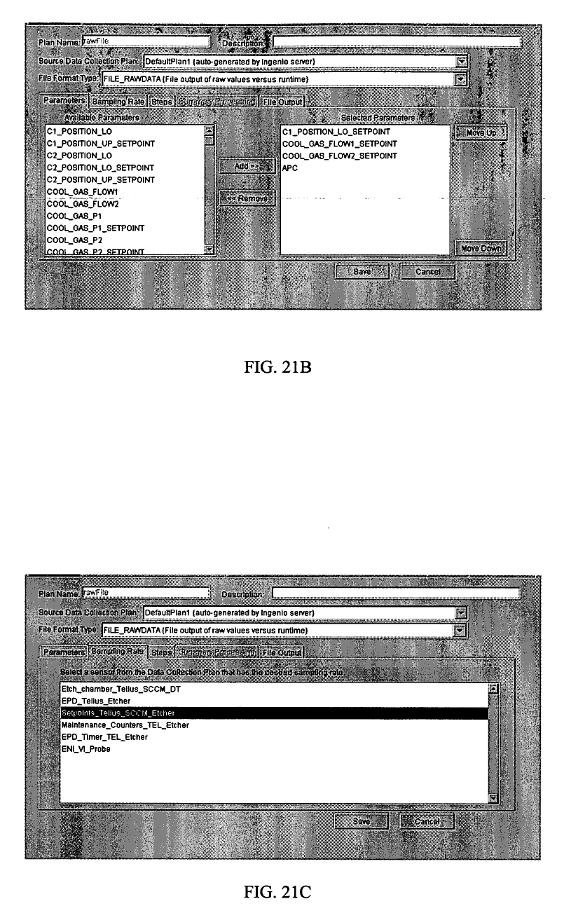

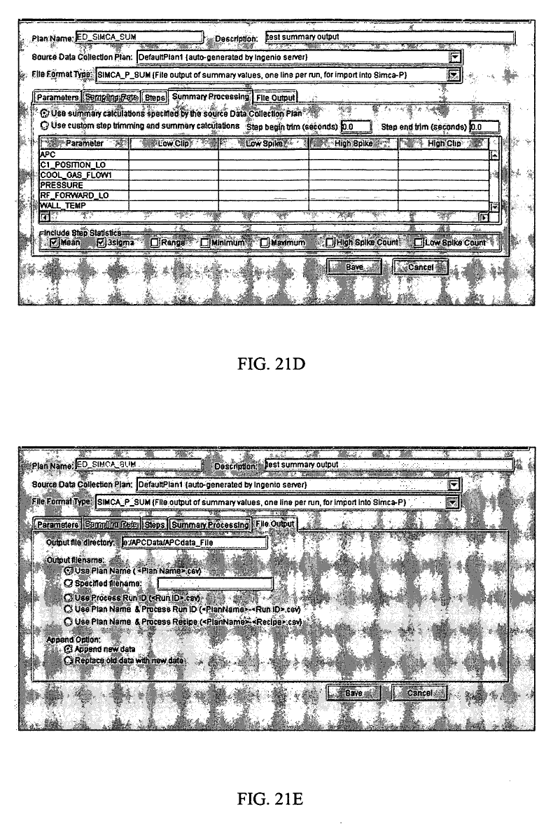

FIGS. 21A-21E show exemplary views of file output plan panels in accordance with one embodiment of the present invention. For example, a file output plan can be used to determine which data is presented in raw data files, summary data files, and Simca-P summary files. In FIG. 21A, a navigation tree is shown, but this is not required for the invention. Alternately, other selection means can be used such as selection tabs, lists, or buttons. A drop-down lists can be shown that allow a user to create a new file output plan, edit a file output plan, save a file output plan, delete a file output plan, associate a file output plan, unassociated a file output plan, import a file output plan, export a file output plan, and perform data preparation. Alternately, other selection means can be used such as selection tabs, menu items, check boxes, or buttons.

The APC system and the APC software auto-generates at least one default file output plan when the APC system and APC software is configured. The auto-generated file output plans can be used to operate the system or serve as an example for a process engineer to use to setup a different file output plan.

For example, the file output plan panels can comprise at least one of: a plan name filed, a plan description field, a data collection plan name field, a file format type field, a parameters sub panel, a sampling rate sub panel, a steps sub panel, a summary processing sub panel, and a file output sub panel.

A file output plan folder, such as “File Output plans” can be opened to display one or more file output plans, such as a raw data file plan, a summary data file plan, or a Simca-P summary file plan. In FIG. 21A, three different file output plans are displayed, and selection means are available that allow a user to display the file output plan setup panels as shown in FIGS. 21B-21D. For example, these panels can be displayed using a mouse button or a sequence of keystrokes.

Files generated by raw data file plans contain raw sensor data for the specified parameters. Each row of the output file contains a raw data entry based upon the output time specified in the data collection plan. For example, if the output time is once per second, each consecutive row will contain raw data for each consecutive second that the wafer was processed.

Files generated by a summary data file plan contain summary data for one or more wafers for the parameters that have been specified. The summary data for a parameter is comprised of the minimum, maximum, average and 3σ value of that parameter over a wafer run. Summary output files typically contain data for multiple wafers; however, the content of the file is based upon the name given the file.

Files generated by Simca P_raw data plans contain raw sensor data for the specified parameters. This data is in a format that is specific to Simca-P. Each row of the output file contains a raw data entry based upon the output time specified in the plan. For example, if the output time is once per second, then each consecutive row will contain raw data for each consecutive second that the wafer was processed. Whether or not the file contains data for multiple wafer runs depends upon how you name the file.

In addition, Simca-P summary files and file plans are designed to facilitate Simca-P modeling. For example, Simca-P summary files may contain the mean value, the 3-sigma value, the minimum value, maximum value, the range, or a combination of these values for each parameter in a plan at each recipe step in the plan.

As described above, the GUI is web-based and is viewable by a user using a web browser. The GUI allows a user to display real-time tool and process module statuses based upon process module events and alarm messages, historical data numerically and/or graphically, SPC charts, APC system logs, and Alarm logs. In addition, the GUI allows a user to print graphs and reports, to save data to files, to export data, to import data, and set up or modify the system.

GUI screens can comprise at least one of a title bar, a navigation bar, a selection bar, a control bar, a message bar, and a GUI panel. Bars can be located along the bottom and/or top of the GUI panels, and these bars can comprise selection items that allow users to navigate between screens and/or panels without having to traverse a series of menus. Desirably, a means for logging off is displayed on at least one screen/panel. In addition, reminder messages can be provided when data has been modified and not saved. In addition, a means for obtaining help can be displayed, and it can be used to view content specific and general documentation to aid the user understand the data being presented to the user and/or the data being requested from the user. Furthermore, a GUI component can comprise at least one screen selected from a group consisting of an English language screen, a Japanese language screen, a Taiwanese language screen, a Chinese language screen, a Korean language screen, a German language screen, and a French language screen.

Numerous modifications and variations of the present invention are possible in light of the above teachings. It is therefore to be understood that, within the scope of the appended claims, the invention may be practiced otherwise than as specifically described herein.

1. An Advanced Process Control (APC) System, for managing a semiconductor processing system, comprising Graphical User Interface (GUI) screens, the GUI screens comprising:
web-based logon GUI screen for providing a secure entry point;
a plurality of GUI status screens for viewing current status of the semiconductor processing system, wherein at least one GUI status screen is accessible from the logon screen;
a plurality of GUI configuration screens for configuring the semiconductor processing system; and
a plurality of data manager GUI screens for managing historical and real-time data for the semiconductor processing system.

2. The APC System as claimed in claim 1, wherein the web-based logon screen provides a secure entry point for a first level user, a second level user, and a third level user, wherein the first level user is restricted to viewing status screens.

3. The APC system as claimed in claim 1, wherein the plurality of GUI status screens comprise a tool status screen, wherein the tool status screen further comprises information for at least one process module.

4. The APC System as claimed in claim 3, wherein the tool status screen further comprises means for allowing a user to select a graphical representation of a process module to display a process module status screen.

5. The APC System as claimed in claim 1, wherein the plurality of GUI status screens comprises at least one processing module status screen comprising at least one of: a lot name field for identifying the name of the lot to which the wafer in a process module belongs; a slot ID field identifying the ID of the slot to which the wafer in a process module belongs; a wafer ID field for identifying the wafer; a recipe ID field for identifying the recipe for a current wafer; a cassette ID field for identifying the cassette from which the wafer came, a wafer start time field, and a wafer end time field.

6. The APC System as claimed in claim 1, wherein the plurality of GUI status screens comprises a chart selection screen for accessing at least one of a tool related chart, a module related chart, a recipe related chart, a step related chart, a parameter related chart, a statistic related chart, and an autoSPC chart.

7. The APC System as claimed in claim 1, wherein the plurality of GUI status screens comprises an alarm log viewer screen for viewing status of at least one of a tool alarm, a processing alarm, a software alarm.

8. The APC System as claimed in claim 1, wherein the plurality of GUI status screens comprises a chart selection screen for accessing at least one of a trace chart, a summary chart, and a SPC chart.

9. The APC System as claimed in claim 1, wherein the plurality of GUI status screens comprises means for viewing sensor status.

10. The APC System as claimed in claim 1, wherein the plurality of GUI configuration screens comprises at least one of: a system configuration screen, a module configuration screen, a sensor configuration screen, and an alarm configuration screen.

11. The APC system as claimed in claim 10, wherein the plurality of GUI configuration screens further comprises a tool instance configuration screen.

12. The APC system as claimed in claim 10, wherein the plurality of GUI configuration screens further comprises a module instance configuration screen.

13. The APC system as claimed in claim 10, wherein the plurality of GUI configuration screens further comprises a sensor instance configuration screen.

14. The APC System as claimed in claim 1, wherein the plurality of GUI configuration screens comprises at least one of a trace chart configuration screen, a summary chart configuration screen, and a SPC chart configuration screen.

15. The APC System as claimed in claim 1, wherein the plurality of data manager GUI screens comprises at least one of: a screen for creating a data collection strategy, a screen for creating a data collection plan, a screen for creating an analysis strategy, and a screen for creating an analysis plan.

16. The APC System as claimed in claim 15, wherein the APC System automatically generates at least one of: the data collection strategy, the data collection plan, the analysis strategy, and the analysis plan

17. The APC System as claimed in claim 1, wherein the plurality of data manager GUI screens comprises at least one of: a screen for viewing status for a data collection strategy, a screen for viewing status for a data collection plan, a screen for viewing status for an analysis strategy, and a screen for viewing status for an analysis plan.

18. The APC System as claimed in claim 1, wherein the plurality of data manager GUI screens comprises at least one of: means for editing a data collection strategy, means for editing a data collection plan, means for editing an analysis strategy, and means for editing an analysis plan.

19. The APC System as claimed in claim 18, wherein the plurality of data manager GUI screens comprises the means for editing a data collection strategy, the means for editing a data collection strategy comprising at least one GUI panel for determining a usage context for the data collection strategy.

20. The APC System as claimed in claim 18, wherein the plurality of data manager GUI screens comprises the means for editing a data collection plan, the means for editing a data collection plan comprising at least one of: a GUI panel for editing sensor instances, a GUI panel for editing sensor parameters, a GUI panel for editing parameter saving information, and a GUI panel for editing a data collection type for a parameter.

21. The APC System as claimed in claim 18, wherein the plurality of data manager GUI screens comprises the means for editing an analysis strategy, the means for editing an analysis strategy comprising at least one GUI panel for determining a usage context for the analysis strategy.

22. The APC System as claimed in claim 18, wherein the plurality of data manager GUI screens comprises the means for editing an analysis plan, the means for editing an analysis plan comprising at least one of: a GUI panel for editing a SPC plan, a GUI panel for editing a PCA plan, a GUI panel for editing a PLS plan, and a GUI panel for editing a file output plan.

23. The APC System as claimed in claim 1, wherein a GUI screen comprises at least one of: a title panel, a control panel, and information panel,

24. The APC System as claimed in claim 23, wherein the GUI screen comprises a title panel comprising company logo block to display version information, user ID block to display the ID of the current user, alarm message block to display a message, current date and time block to display the current date and time of the server, current screen name block to display the name of the current screen, communication status block to display the current status for communications link between server and tool, tool ID block to display the ID of the tool being monitored, logoff block to allow a user to log off, and screen select block to view a list of all available screens.

25. The APC System as claimed in claim 23, wherein the GUI screen comprises a control-panel comprising a plurality of selection items enabling a user to display screens including a tool status screen, process module screen, charts screen, alarm log screen, SPC screen, data manager screen, and help screen.

26. The APC System as claimed in claim 1, wherein at least one GUI screen comprises a navigation tree selection menu.

27. The APC System as claimed in claim 1, wherein at least one GUI screen comprises a user-expandable navigation tree for displaying selectable items.

28. The APC System as claimed in claim 27, wherein the user-expandable navigation tree comprises at least one of: processing tool information, processing module information, strategy information, and plan information.

29. The APC System as claimed in claim 28, wherein the user-expandable navigation tree comprises the processing tool information, the processing tool information comprising information about at least one of an etching tool, a deposition tool, a cleaning tool, and a transfer tool.

30. The APC System as claimed in claim 28, wherein the user-expandable navigation tree comprises the strategy information, the strategy information comprising at least one of a control strategy and an analysis strategy.

31. The APC System as claimed in claim 28, wherein the user-expandable navigation tree comprises the plan information, the plan information comprising at least one of a data collection plan and an analysis plan,

32. The APC System as claimed in claim 1, wherein the plurality of GUI screens comprises at least one screen selected from a group consisting of an English language screen, a Japanese language screen, a Taiwanese language screen, a Chinese language screen, a Korean language screen, a German language screen, and a French language screen.

33. The APC System as claimed in claim 1, wherein at least one GUI screen comprises a multi-level navigation tree selected from a group consisting of an English language multi-level navigation tree, a Japanese language multi-level navigation tree, a Taiwanese language multi-level navigation tree, a Chinese language multi-level navigation tree, a Korean language multi-level navigation tree, a German language multi-level navigation tree, and a French language multi-level navigation tree.

34. A method for managing a semiconductor processing system using an Advanced Process Control (APC) System comprising Graphical User Interface (GUI) screens, the method comprising:
providing a secure entry point using a web-based logon screen;
providing a plurality of GUI status screens for viewing current status of the semiconductor processing system, wherein at least one GUI status screen is accessible from the logon screen;
providing a plurality of GUI configuration screens for configuring the semiconductor processing system; and
providing a plurality of data manager GUI screens for managing historical and real-time data for the semiconductor processing system.

35. The method as claimed in claim 34, wherein the method further comprises providing a GUI screen for viewing at least one of: tool status, module status, and sensor status.

36. The method as claimed in claim 34, wherein the method further comprises providing a GUI screen for configuring at least one of: a tool, a processing module, and a sensor.

37. The method as claimed in claim 34, wherein the method further comprises providing at least one of: a screen for creating a data collection strategy, a screen for creating a data collection plan, a screen for creating an analysis strategy, and a screen for creating an analysis plan.

38. The method as claimed in claim 34, wherein the method further comprises providing at least one of: a screen for viewing status for a data collection strategy, a screen for viewing status for a data collection plan, a screen for viewing status for an analysis strategy, and a screen for viewing status for an analysis plan.

39. The method as claimed in claim 34, wherein the method further comprises providing at least one of: means for editing a data collection strategy, means for editing a data collection plan, means for editing an analysis strategy, and means for editing an analysis plan.

40. The method as claimed in claim 34, wherein the method further comprises providing at least one screen selected from a group consisting of an English language screen, a Japanese language screen, a Taiwanese language screen, a Chinese language screen, a Korean language screen, a German language screen, and a French language screen.
